(19) United States
(12) Patent Application Publication
(10) Pub. No.: US 2026/0169503 A1
(43) Pub. Date: Jun. 18, 2026

(54) CONTROL DEVICE, CONTROL SYSTEM, CONTROL METHOD AND STORAGE MEDIUM

(71) Applicant: NEC Corporation, Minato-ku, Tokyo (JP)

(72) Inventor: Mineto SATOH, Tokyo (JP)

(73) Assignee: NEC Corporation, Minato-ku, Tokyo (JP)

(21) Appl. No.: 18/721,240

(22) PCT Filed: Dec. 20, 2021
(86) PCT No.: PCT/JP2021/046955

§ 371 Date: Jun. 18, 2024

(51) Int. Cl. G05D 1/689; B25J 5/00; G05B 19/4155; G05D 1/698; G05D 101/00

(52) U.S. Cl. CPC G05D 1/6895; G05B 19/4155; G05D 1/6987; B25J 5/00; G05B 2219/40113; G05D 2101/22

(57) ABSTRACT

A control device determines, in accordance with a target task that is a process to be executed by a plurality of controlled devices, an operation sequence for each of the controlled devices. The operation sequence is a time series of predetermined sub-tasks serving as operations capable of being executed by the controlled device or the control device itself. The control device sets, with regard to a sub-task that requires a setting of a time series of control target values with respect to the controlled device, among the sub-tasks included in the operation sequence, a time series of the target values for causing the controlled device to execute the sub-task. The control device controls the controlled devices based on the operation sequence and the target value time-series.

### TECHNICAL FIELD

The present invention relates to a control device, a control system, a control method, and a storage medium.

### BACKGROUND ART

With regard to the control of mobile robots, Patent Document 1 describes a robot moving through a warehouse that generates and updates a map of the warehouse. In this map, fixed objects such as shelves and walls are shown as no-go areas, and collision risks with other robots and humans are shown as superimposed cost images. When a robot moves through the warehouse referring to this map, the superimposed cost images of all other robots are included in the map, but not the superimposed cost images of the robots themselves that refer to the map.

In addition, Patent Document 2 describes a work planning device that generates a work plan for a control system including multiple devices such as robots. This work planning device stores a process information table that shows information about the processes to be executed by the device. The work planning device then generates a work plan that connects the processes shown in the process information table, using the work content input from the user as the goal. Each process in the work plan is assigned to any of several devices.

The work planning device then simulates the work based on the generated work plan and calculates the overall work time, including the work time of each process, the waiting time caused by dependencies between processes, and the interlock time caused by interference between devices. The work planning device then determines whether the overall work time is optimized. If it is determined that the work plan is not optimized, the work planning device repeats the generation and simulation of the work plan until it is determined that it is optimized.

On the other hand, if it is determined that the overall work time is optimized, the work planning device transmits the work plan to the control system, and each device in the control system operates based on the work plan.

In addition, the Patent Document 2 describes that when the work planning device dynamically performs work planning, optimization may be performed for some processes in the work plan depending on the time remaining before the next instruction to the control system is issued.

### PRIOR ART DOCUMENTS

### Patent Documents

Patent Document 1: Published Japanese Translation No. 2019-513994 of the PCT International Publication for Patent Application
Patent Document 2: Japanese Unexamined Patent Application Publication No.

### SUMMARY OF THE INVENTION

### Problems to be Solved by the Invention

When processing with multiple controlled devices such as multiple mobile robots, it is desirable that the processing load of control for these multiple controlled devices not be concentrated at a specific time.

An example of an object of the present invention is to provide a control device, a control system, a control method, and a storage medium that can solve the above-mentioned problems.

### Means for Solving the Problem

According to a first example aspect of the invention, a control device includes: a first plan generation means that determines, in accordance with a target task that is a process to be executed by a plurality of controlled devices, an operation sequence for each of the controlled devices, the operation sequence being a time series of predetermined sub-tasks serving as operations capable of being executed by the controlled device or the control device itself; a second plan generation means that, with regard to a sub-task that requires a setting of a time series of control target values with respect to the controlled device, among the sub-tasks included in the operation sequence, sets a time series of the target values for causing the controlled device to execute the sub-task; and a control means that controls the controlled devices based on the operation sequence and the target value time-series.

According to a second example aspect of the invention, a control system includes: a plurality of controlled devices; and a planning device, the planning device includes: a first plan generation means that determines, in accordance with a target task that is a process to be executed by the controlled devices, an operation sequence for each of the controlled devices, the operation sequence being a time series of predetermined sub-tasks serving as operations capable of being executed by the controlled device or the planning device; and a second plan generation means that, with regard to a sub-task that requires a setting of a time series of control target values with respect to the controlled device, among the sub-tasks included in the operation sequence, sets a time series of the target values for causing the controlled device to execute the sub-task.

According to a third example aspect of the invention, a control method executed by a computer that controls a plurality of controlled devices includes: determining, in accordance with a target task that is a process to be executed by the controlled devices, an operation sequence for each of the controlled devices, the operation sequence being a time series of predetermined sub-tasks serving as operations capable of being executed by the controlled device or the computer itself; setting, with regard to a sub-task that requires a setting of a time series of control target values with respect to the controlled device, among the sub-tasks included in the operation sequence, a time series of the target values for causing the controlled device to execute the sub-task; and controlling the controlled devices based on the operation sequence and the target value time-series.

According to a fourth example aspect of the invention, a storage medium records a program for causing a computer that controls a plurality of controlled devices to execute: determining, in accordance with a target task that is a process to be executed by the controlled devices, an operation sequence for each of the controlled devices, the operation sequence being a time series of predetermined sub-tasks serving as operations capable of being executed by the controlled device or the computer itself; setting, with regard to a sub-task that requires a setting of a time series of control target values with respect to the controlled device, among the sub-tasks included in the operation sequence, a time series of the target values for causing the controlled device to execute the sub-task; and controlling the controlled devices based on the operation sequence and the target value time-s

### Effects of Invention

According to the present invention, when processing is performed using multiple controlled devices, it is possible to avoid that the processing load for control of these multiple controlled devices be concentrated at a specific time.

### BRIEF DESCRIPTION OF THE DRAWINGS

FIG. 1 is a diagram showing an example of the configuration of the control system according to the first example embodiment.

FIG. 2 is a diagram showing an example of the functional configuration of the control system for the first example embodiment.

FIG. 3 is a diagram showing an example of the data structure of accumulated information stored by the accumulated information storage portion of the first example embodiment.

FIG. 4 is a flowchart showing an example of the processing steps performed by the control system for the first example embodiment.

FIG. 5 is a diagram showing an example of the display of the task input screen that receives input operations by the user when the target task is picking in the first example embodiment.

FIG. 6 is a diagram showing an example of variable values calculated by the first plan generation portion according to the first example embodiment.

FIG. 7 is a flowchart showing an example of a processing procedure in which the first plan generation portion according to the first example embodiment generates an operation sequence from a target logical expression.

FIG. 8 is a diagram showing an example of an operation sequence assuming a case in which an object conveyed by a mobile robot of the first example embodiment is picked by another mobile robot and conveyed to another location.

FIG. 9 is a diagram showing an example of the abstract state setting space according to the first example embodiment.

FIG. 10 is a diagram schematically illustrating the trajectories of the movement portion of a mobile robot and the robot arm portion of a robot, which are output by the second plan generation portion according to the first example embodiment.

FIG. 11 is a diagram showing an example of a sub-task that further divides a part of the sub-tasks included in the operation sequence when two mobile robots cooperate to transport an object in accordance with the first example embodiment.

FIG. 12 is a diagram showing a first modification of the control system according to the first example embodiment.

FIG. 13 is a diagram showing a second modification of the control system according to the first example embodiment.

FIG. 14 is a diagram showing an example of the mounting location of the observation device on the mobile robot in the second modification of the control system for the first example embodiment.

FIG. 15 is a diagram showing a third modification of the control system according to the first example embodiment.

FIG. 16 is a diagram showing a fourth modification of the control system according to the first example embodiment.

FIG. 17 is a diagram showing an example of the configuration of the control system according the second example embodiment.

FIG. 18 is a diagram showing an example of the assignment of processing among devices by the first plan generation portion according to the second example embodiment.

FIG. 19 is a diagram showing an example of the configuration of the control device according to the third example embodiment.

FIG. 20 is a diagram showing an example of the configuration of the control system according the fourth example embodiment.

FIG. 21 is a flowchart showing an example of the processing steps in the operation planning method according to the fifth example embodiment.

FIG. 22 is a schematic block diagram showing the configuration of a computer according to at least one example embodiment.

### EXAMPLE EMBODIMENT

The following is a description of example embodiments of the present invention, but the following example embodiments shall not limit the invention as claimed. Not all of the combinations of features described in the example embodiments are essential to the solution of the invention.

In the descriptions and drawings of the following example embodiments, the same reference numerals indicate similar items unless otherwise noted. In the description of the following example embodiments, repeated descriptions may be omitted for similar configurations or operations.

### First Example Embodiment

### (Device Configuration)

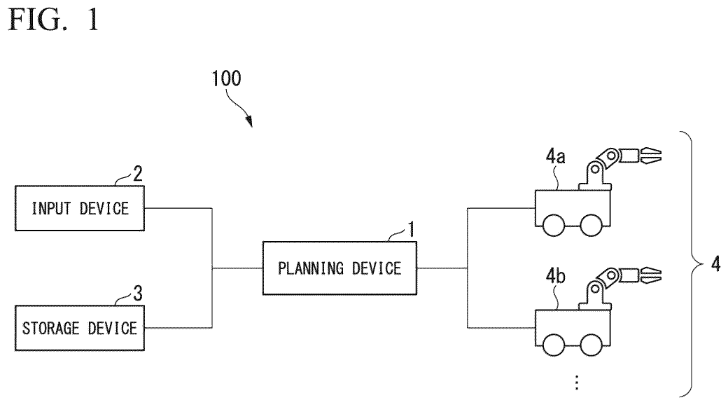

FIG. 1 is a diagram showing an example of the configuration of the control system according to the first example embodiment. In the configuration shown in FIG. 1, a control system 100 includes a planning device 1, an input device 2, a storage device 3, and at least two or more mobile robots 4a, 4b, . . . .

The mobile robots 4a, 4b, . . . are also collectively referred to as mobile robots 4.

The following description is based on the case where the controlled device in the control system is a mobile robot, but is not limited thereto. For example, this and the following example embodiments can be applied when the controlled device is a machine tool.

When the process to be performed by one or more mobile robots 4 is specified, the control system 100 determines the time series of operations to be performed by the individual mobile robots 4. The process to be executed by the mobile robots 4 is also referred to as the target task. Information indicating the target task is also referred to as task information. A time operation sequence is also referred to as an operation sequence or simply a sequence. Information indicating the operation sequence is also referred to as operation sequence information or simply sequence information.

For the determined operation sequence requiring the setting of a time series of control target values with respect to the mobile robot 4, the control system 100 sets the time series of the target values for the operation.

The planning device 1 is connected to each of the input device 2, storage device 3, and mobile robots 4 by wired or wireless communication. These methods of communication are not limited to any particular method. For example, from the viewpoint of avoiding communication cables limiting the range of movement of the mobile robots 4, wireless communication between the planning device 1 and individual mobile robots 4 is preferred, but is not limited thereto.

The planning device 1 controls the mobile robots 4 to perform the target task.

Specifically, the planning device 1 performs the process of determining the operation sequence for each of the mobile robots 4 based on the target task, as described above for the control system 100. The planning device 1 then generates control signals according to the determined operation sequence and sends them to each of the mobile robots 4. In this way, the planning device 1 controls each of the mobile robots 4.

The planning device 1 is an example of a control device.

The input device 2 receives data input. The input device 2 may function as a user interface and receive data input by the user. For example, the input device 2 may comprise a touch panel, buttons, keyboard, or voice input device, or a combination of these.

The input device 2 may receive task information input by user operation and transmit the acquired task information to the planning device 1.

The storage device 3 stores various types of information. For example, information about the mobile robot 4, information about the target task, and information about the environment may be stored in the storage device 3.

The storage device 3 may consist of an external storage medium such as a hard disk or USB (Universal Serial Bus) flash memory that is communicatively connected to the planning device 1. Alternatively, the storage device 3 may be built into the planning device 1.

Alternatively, the storage device 3 may be configured as part of a device other than the planning device 1. For example, the storage device 3 may be included in a server device connected to the planning device 1 by wireless or wired communications.

The storage device 3 may be configured as a single device or as part of a single device. Alternatively, the storage device 3 may be configured as multiple devices or as part of multiple devices. For example, the storage device 3 may be mounted on multiple mobile robots 4.

The mobile robot 4 operates according to the control of the planning device 1. In particular, the individual mobile robots 4 operate according to the operation sequence determined by the planning device 1 to perform the target task across the multiple mobile robots 4.

### (Functional Configuration)

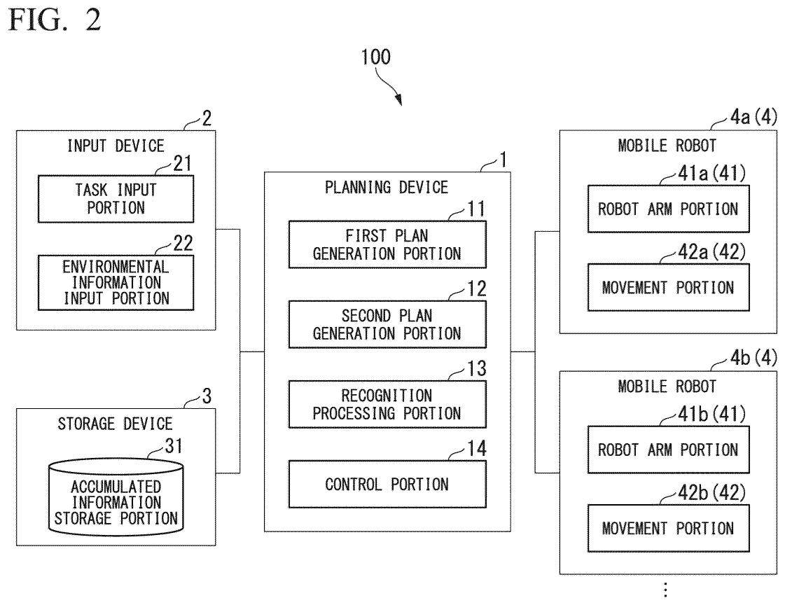

FIG. 2 is a diagram showing an example of the functional configuration of the control system 100. FIG. 2 shows an example of the functional configuration of the control system 100 shown in FIG. 1. As described above, the control system 100 includes a planning device 1, an input device 2, a storage device 3, and mobile robots 4.

Furthermore, in the configuration shown in FIG. 2, the planning device 1 includes a first plan generation portion 11, a second plan generation portion 12, a recognition processing portion 13, and a control portion 14. The input device 2 includes a task input portion 21 and an environmental information input portion 22. The storage device 3 includes an accumulated information storage portion 31. The mobile robot 4 has a robot arm portion 41 and a movement portion 42.

When distinguishing the robot arm portion 41 for each mobile robot 4, they are denoted as robot arm portions 41a, 41b, and so on, corresponding to the notation of the mobile robots 4a, 4b, and so forth. When distinguishing the movement portion 42 for each mobile robot 4, they are denoted as movement portions 42a, 42b, and so on, corresponding to the notation of the mobile robots 4a, 4b, and so forth.

The task input portion 21 obtains task information input by the user. As described above for the input device 2, the task input portion 21 may function as a user interface and receive data input by the user. For example, the task input portion 21 may comprise a touch panel, buttons, keyboard, or voice input device, or a combination of these.

Alternatively, the task input portion 21 may obtain task information by a method other than receiving user input, such as receiving task information from another device. For example, the control system 100 may be configured as a subsystem in a logistics system. The task input portion 21 may then receive task information transmitted by a higher-level server device to the control system 100.

The environmental information input portion 22 obtains environmental information. The environmental information input portion 22 is an example of an environmental information input means.

Environmental information here is information that indicates the conditions in the space where the mobile robots 4 perform the target task. The environmental information includes information indicating the location of objects in the space where the mobile robots 4 perform the target task.

The space in which the mobile robots 4 perform the target task is also referred to as the work space of the mobile robots 4 or simply the work space. The work space may be set up to include not only the space in which the mobile robots 4 actually or potentially move, but also the space around it. For example, if the mobile robots 4 operate in a factory, the space in that factory may be set as the work space.

The environmental information input portion 22 may be configured using one or a plurality of sensors, which may be a camera, a range sensor, or sonar, or a combination of these sensors, which observe the work space as their observation range.

In cases where the environmental information input portion 22 includes a camera, the camera may be a 2D camera (a camera that captures two-dimensional images) or a 3D camera (a camera that captures three-dimensional images).

The range sensor is not limited to a specific one when the environmental information input portion 22 uses a range sensor. For example, LiDAR (Light Detection And Ranging) or RADAR (Radio Detection And Ranging) may be used as the range sensor in this case, but the range sensor is not limited thereto.

The sensors provided by the environmental information input portion 22 may be installed in a fixed manner in positions where they can observe inside the work space. Alternatively, the sensors provided by the environmental information input portion 22 may be movable. For example, the sensors provided by the environmental information input portion 22 may be mounted on one or more of the mobile robots 4.

In addition to, or instead of, using sensors to obtain environmental information or a portion thereof, the environmental information input portion 22 may also obtain environmental information or a portion thereof input by the user. For example, the environmental information input portion 22 may be integrally configured with the task input portion 21 to receive user input of environmental information or a portion thereof, in addition to receiving user input of task information. Alternatively, the environmental information input portion 22 may have a separate input device from the task input portion 21.

Environmental information is information about the environment required to execute each sub-task. Each sub-task may have different items included in the environmental information. For example, for each sub-task, the sensors used to acquire environmental information and the regions or objects from which environmental information is to be acquired may be predetermined. A region here is also referred to as the field of view, target area, or region of interest (ROI).

For example, if the sub-task is picking, the environmental information may be 2D or 3D information in the work space containing the object to be picked. In this case, the environmental information may be RGB (Red-Green-Blue) images, 3D depth, point cloud data, or the like.

If the sub-task is placing, the environmental information may include the location where the object is to be placed. The environmental information may include, in addition to or instead of information on the object to be manipulated, information on objects that may be an obstacle to manipulation (called obstacles).

There is also environmental information that corresponds one-to-one with sub-tasks and environmental information used by multiple sub-tasks. An example of environmental information that corresponds one-to-one with a sub-task is information about the object of the operation in the sub-task. Environmental information used in multiple sub-tasks includes information on obstacles in multiple sub-tasks that operate the object.

The object here is the object to be handled by the mobile robots 4 in the target task. For example, if the target task is to transport objects, the objects to be transported are examples of objects. If the target task is to process an object, the thing to be processed is an example of an object. The object is also referred to as a workpiece.

If the target task is a task that does not involve the handling of things, such as security, the object is not specified.

Sub-tasks here are the operations of the mobile robots 4 or the planning device 1, which are predefined as parts in the operation sequence generated by the planning device 1 for each mobile robot 4. Accordingly, sub-tasks are operations that are predefined as operations that can be performed by the mobile robot 4 or the planning device 1. The planning device 1 can combine sub-tasks to generate an operation sequence.

For example, “move,” “recognize,” “retrieve,” and “place” sub-tasks may be specified.

In “move,” the mobile robot 4 moves.

In “recognize,” the mobile robot 4 recognizes things such as objects.

In “retrieve,” the mobile robot 4 retrieves the object from a predetermined location with the robot arm portion 41. The sub-task of “retrieve” is also referred to as the sub-task of “pick.”

In “place,” the mobile robot 4 places the object at a predetermined location with the robot arm portion 41.

The robot arm portion 41 manipulates the object. Manipulation of the object by the robot arm portion 41 can be a variety of predetermined manipulations and is not limited to any particular manipulation. For example, if the target task is to move the object, the manipulation of the object by the robot arm portion 41 may include picking the object, moving the object relative to the mobile robot 4 with the object picked, and releasing the picked object. When the mobile robot 4 operates as a machine tool, the manipulation of the object by the robot arm portion 41 may include machining of the object.

The robot arm portion 41 is also referred to as the manipulator. Manipulation of the object by the robot arm portion 41 is also referred to as manipulation.

The movement portion 42 is configured as a drive mechanism of the mobile robot 4, such that by the movement portion 42 itself moving, the mobile robot 4 equipped with the movement portion 42 is made to move. The mobile robot 4 transports objects by moving in the state where the robot arm portion 41 has picked the object or in a state where the mobile robot 4 itself has placed the object.

The first plan generation portion 11 determines the operation sequence for each mobile robot 4 and generates operation sequence information. The first plan generation portion 11 determines the operation sequence by assigning the order and timing in which manipulations should be performed for each mobile robot 4 in units of sub-tasks such as moving, recognizing, picking, and placing. Thus, the first plan generation portion 11 schedules the operations to be performed by the mobile robots 4, for each mobile robot 4 and in units of sub-tasks.

The first plan generation portion 11 is an example of a first plan generation means.

For the assigned sub-tasks that require time-series operations, the second plan generation portion 12, generates time-series control commands for the movement portion 42 or the robot arm portion 41, or both, that constitute the mobile robot 4, for every mobile robot. A sub-task that requires time-series operations can also be said to be a sub-task that requires the setting of a time series of target values for control.

In other words, the second plan generation portion 12 generates time-series control commands to move and manipulate each mobile robot 4. Picking and placing are examples of sub-tasks that require time-series movements. The time series control command here is a time series of control commands, i.e., control commands at each time of day.

In particular, the second plan generation portion 12 outputs the trajectory for moving the mobile robot 4 by the movement portion 42 and the trajectory for moving the robot arm portion 41. The trajectory here is the path of movement of an object and is indicated by a series of time-specific positional information. The series of time-specific positional information set as trajectories by the second plan generation portion 12 corresponds to an example of a time series of target values to be executed by the mobile robot 4.

Thus, the second plan generation portion 12 generates and outputs time-series control commands for sub-tasks involving the setting of target trajectories.

The second plan generation portion 12 is an example of a second plan generation means.

The recognition processing portion 13 and the control portion 14 are both processing portions that perform processing corresponding to the execution of sub-tasks. Specifically, the recognition processing portion 13 performs the “recognize” sub-task. The control portion 14 executes sub-tasks to control the control target according to the time-series control commands generated by the second plan generation portion 12, such as “pick” and “place”. As mentioned above, examples of the control objects here are the movement portion 42 and the robot arm portion 41.

The recognition processing portion 13 obtains the information necessary to execute each sub-task from the environmental information obtained by the environmental information input portion 22. For example, if the sub-task to be performed is picking, the recognition processing portion 13 may obtain information indicating the type and number of objects to be picked and information indicating the position and orientation of each object. Regarding placement, the recognition processing portion 13 may acquire information such as the location (coordinates) or spatial extent of the place where the object is to be placed, and the direction in which the object is to be moved for placement.

The recognition processing portion 13 is an example of a recognition processing means.

Various recognition methods can be applied by the recognition processing portion 13 as methods to obtain this information from the environmental information, and are not limited to any particular method. For example, the recognition processing portion 13 may use methods based on image processing of 2D or 3D images to obtain the above information. Alternatively, the recognition processing portion 13 may use a neural network such as deep learning to obtain the above information.

Alternatively, if the environmental information input portion 22 receives user input of information necessary for sub-task execution as described above as environmental information, the recognition processing portion 13 may output the environmental information obtained by the environmental information input portion 22 as is. In this case, the recognition processing portion 13 does not need to perform the above process.

Based on the sub-tasks, the control portion 14 generates and outputs control signals for controlling the robot arm portion 41 and the movement portion 42 of each mobile robot 4. For example, if the sub-task to be performed is picking, the second plan generation portion 12 generates a target trajectory for the robot arm portion 41 until it approaches the object, using the information about the object obtained by the recognition processing portion 13. The control portion 14 then generates control signals to move the robot arm portion 41 along the target trajectory and transmits them to the mobile robot 4.

The control portion 14 is an example of a control means.

For example, the control portion 14 may generate time-series orientation information of the robot arm portion 41 when the robot arm portion 41 operates along the target trajectory. The control portion 14 may then generate control signals for actuators such as servo motors of the robot arm portion 41 to execute the orientation calculated as orientation information and send the control signals to the mobile robot 4. Alternatively, the control portion 14 may transmit the time-series orientation information of the robot arm portion 41 to the mobile robot 4. The mobile robot 4 may then operate the robot arm portion 41 according to the orientation information.

When the control portion 14 calculates the orientation information of a control target such as the robot arm portion 41, the accumulated information storage portion 31 may store the information necessary to calculate the orientation information. The information required to calculate orientation information may include, but is not limited to, conversion rules from trajectory information to orientation information, for example.

The range that the robot arm portion 41 can approach can be calculated based on the operation limit information of that robot arm portion 41 stored in the accumulated information storage portion 31, or on constraint condition information dependent on obstacles or the surrounding environment. If the conditions indicated as the range that the robot arm portion 41 can approach do not hold, a situation may arise where the robot arm portion 41 cannot reach the object. In such a case, the control portion 14 can output a control signal to the movement portion 42 of the mobile robot 4 instructing it to move the mobile robot 4 to a position where the robot arm portion 41 can reach the object. In other words, the mobile robot 4 is made capable of performing the desired sub-task by moving its self-position and changing the position of the robot arm portion 41.

The accumulated information storage portion 31 stores accumulated information. The accumulated information includes information indicating the operation limitations of the mobile robot 4, information indicating the target task, and information about the environment.

While the environmental information obtained by the environmental information input portion is information obtained in real time, such as sensor measurements, the accumulated information is information that is stored in the accumulated information storage portion 31 and read out as described above.

The above “information on the environment” includes, for example, environmental map information. The environmental map information may be information indicating the arrangement of objects in the work space, as measured by sensors or other means at some time in the past. Alternatively, the environmental map information may be design information (information other than actually measured information), such as information indicating the planned placement of objects in the work space.

The accumulated information may be distributed and stored in multiple locations. For example, if the storage device 3 is configured as multiple devices, the accumulated information may be distributed and stored in those multiple devices.

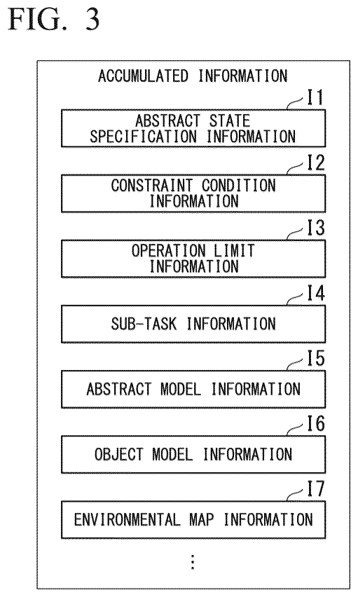

FIG. 3 is a diagram showing an example of the data structure of accumulated information stored by the accumulated information storage portion 31. In the example in FIG. 3, the accumulated information includes abstract state specification information I1, constraint condition information I2, operation limit information I3, sub-task information I4, abstract model information I5, object model information I6, and environmental map information I7.

The abstract state specification information I1 is information that specifies the abstract state that needs to be defined in order to assign sub-tasks to each mobile robot 4. The abstract state here is an abstract representation of the state of an object in the work space. The method and degree of abstraction in the abstract state is not limited to any particular method or degree.

The abstraction here may be to replace some information with less data-intensive information, for example, calculating the position information of the center of gravity of an object based on the point cloud information of the object's position obtained as sensor measurements.

The degree of abstraction here may be the degree of reduction in the amount of data due to abstraction. For example, the degree of abstraction may be a setting of whether the object's location is represented in two or three dimensions. The setting of the degree of abstraction may be a setting of whether or not to include information on the size of the object and an orientation vector in the position information, in addition to the position information of the object's center of gravity.

In the abstract state specification information I1, the abstract state may be defined as a proposition used in the target logical expression described below.

In the abstract state specification information I1, the state of the object according to the type and content of the target task may be indicated in the form of an abstract state.

For example, consider the case where the target task is to take an object from a location designated as the source location, transport it, and place it at a location designated as the destination location. In this case, the reference location of the source location, the location of the object and obstacles, and the reference location of the destination location may be indicated in the form of an abstract state.

The target task, which is the task of taking an object from a location designated as the source location, transporting it, and placing it at a location designated as the destination location, is also referred to as pick and place or simply picking. To distinguish between the target task and sub-tasks, “task” may be explicitly indicated after the name of the target task. For example, picking is also referred to as a picking task.

A picking tasks can be performed as picking, parts supply, or sorting tasks, or parts thereof, depending on the industry. Parts supply or sorting may be set as the target task.

Alternatively, tasks such as assembly, inspection or security may be set as target tasks.

Thus, various tasks, not just picking tasks, can be target tasks. Any task set as a target task may be a task that at least two or more mobile robots 4 cooperate to perform.

The constraint condition information I2 is information that indicates the constraint conditions when executing the target task. For example, if the target task is a picking task, constraint conditions indicated by the constraint condition information I2 may include constraint conditions such as “the mobile robot 4 cannot reach the object unless the distance between its own position and the object is equal to or less than a specified value,” “the mobile robot 4 must not contact any obstacle, wall or other structure,” and “the robot arm must not be moved while the mobile robot 4 is moving”.

The constraint condition information I2 may be recorded for each target task, in association with information indicating the type or content of the target task.

The constraint conditions indicated by the constraint condition information I2 may also include constraint conditions between multiple mobile robots 4. For example, the constraint conditions indicated by the constraint condition information I2 may include constraint conditions such as “the mobile robots 4 must not contact each other” and “the mobile robots 4 must not execute different sub-tasks until they are separated by a certain distance”.

The operation limit information I3 is information about the operation limit of the mobile robot 4 controlled by the control portion 14.

For example, the operation limit information I3 may include information indicating the operation limit of the movement portion 42. Examples of the operation limits of the movement portion 42 include, but are not limited to, the maximum speed of the mobile robot 4, the maximum acceleration of the mobile robot 4, the distance between the mobile robot 4 and the obstacle that must be maintained when the mobile robot 4 avoids the obstacle, and the distance required until the mobile robot 4 stops.

The operation limit information I3 may include information indicating the operation limit of the robot arm portion 41. Examples of operation limits of the robot arm portion 41 include, but are not limited to, the maximum angular velocity of each joint of the robot arm portion 41, the maximum angular acceleration of each joint, the range of motion of each joint (e.g., rotation angle), and the maximum distance from the base of the robot arm to the tip.

As the operation limit information I3, information indicating the operation limit of each mobile robot 4 may be recorded for each mobile robot 4, in association with the identification information of that mobile robot 4.

The sub-task information I4 is information indicating sub-tasks that can be executed by the mobile robot 4. For example, if the target task is a picking task, the sub-task information I4 may include information specifying sub-tasks such as moving, recognizing, picking, and placing.

The “move” sub-task is a sub-task in which the movement portion 42 of the mobile robot 4 moves autonomously to the reference position serving as a target. The “pick” sub-task is a sub-task in which the robot arm portion 41 moves so as to reach the reference position serving as the target and picks the object. The “place” sub-task is the sub-task of placing an object. Place is also referred to as attach.

Note that when the “move” sub-task is executed, the trajectory of the intermediate route to the target position shall have been generated by other processes.

The sub-task information I4 may include any of the following, or a combination of the two: information indicating the specified value of the time required for the mobile robot 4 to complete execution of each sub-task, or information indicating the processing power required to execute each sub-task. Examples of information indicating the processing power required to execute each sub-task include, but are not limited to, information indicating the specified value of CPU utilization of the computing device.

Furthermore, the sub-task information I4 may include information indicating constraint conditions, such as constraint conditions when multiple mobile robots 4 are working together, or constraint conditions on the order relationship between sub-tasks. An example of a constraint condition in this case could be, but is not limited to, “Once the mobile robot 4a finishes sub-task A, mobile robot 4b can execute sub-task B.”

The sub-task information I4 may be recorded for each target task, in association with information indicating the type or content of the target task.

The abstract model information I5 is information about the model that abstracts the dynamics in the work space. The dynamics here are items whose values can change in the model, such as the state of an object. The model that abstracts the dynamics in the workspace is also referred to as the abstract model and is denoted by “Σ”. The method and degree of abstraction in abstract model information is not limited to any particular method or degree.

The abstract model “Σ” may be constructed as a model that abstracts the dynamics of reality by means of a hybrid system. The hybrid system here is a system in which logical variables and continuous variables are mixed. Logical variables are variables that take discrete values. Logical variables may be subject to logical operations. Dynamics denoted by logical variables are referred to as discrete dynamics. Continuous variables are variables that take on continuous values. Continuous variables may be the subject of quantitative operations. Dynamics indicated by continuous variables are referred to as continuous dynamics.

Abstract model information I5 may contain information indicating the conditions for switching dynamics in the hybrid system described above. The dynamics subject to switching are discrete dynamics and are represented by logical variables. The switching of dynamics is represented by a change in the value of a logical variable. For example, if the target task is a picking task, information indicating conditions for switching such as “The distance between the position of the mobile robot 4 and the object must be less than or equal to the value recorded in the constraint condition information I2 to reach the object,” “The object to be transported must be picked by the robot arm to move” may be included in the abstract model information I5.

The abstract model information I5 may be recorded for each target task, associated with information indicating the type or content of the target task.

The object model information I6 may include information about the model indicating the object to be recognized by the recognition processing portion 13. The model representing the object to be recognized by the recognition processing portion 13 is also referred to as the object model. For example, the object model information I6 may include the information necessary to recognize any of the type, position and orientation, or a combination thereof, of each object and three-dimensional shape information such as CAD (Computer Aided Design) data to recognize the 3D shape of each object.

The object model information I6 may contain information about objects other than the object. For example, if the object is located above or next to another object, object A, the object model information I6 may contain information about a model representing object A.

When the recognition processing portion 13 performs recognition processing using an inferential unit that has been pre-trained by machine learning, such as a neural network, the object model information I6 may include information such as the parameter values of that inferential unit.

The object model information I6 may be recorded for each target task, associated with information indicating the type or content of the target task.

The environmental map information I7 is information that shows a map within the work space. More specifically, the environmental map information I7 indicates the location of objects in the work space. For example, if the target task is a picking task, the environmental map information I7 may include information indicating the current position of each mobile robot 4, information indicating the reference position of the location where the mobile robots 4 perform picking, information indicating the range where the mobile robots 4 can move along the transport path such as aisles, information indicating the position, size and range of structures such as walls that are obstacles, and information indicating the reference position of the location where the objective object is to be placed.

The environmental map information I7 may be stored in the accumulated information storage portion 31 in advance. Alternatively, the planning device 1 or the mobile robot 4 may use sensing data from sensors mounted on each mobile robot 4 to generate environmental map information I7 as the mobile robot 4 moves.

A method called SLAM (Simultaneous Localization And Mapping) can be used to generate environmental map information I7 using sensing data from sensors mounted on each mobile robot 4, but is not limited to this method.

### (Operation)

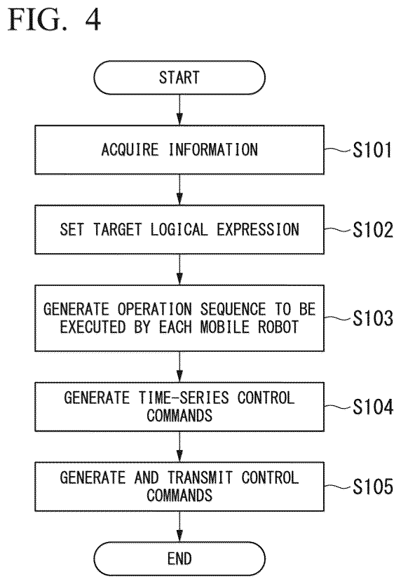

FIG. 4 is a flowchart showing an example of the processing steps performed by the control system 100.

In the process shown in FIG. 4, the planning device 1 acquires various types of information (Step S101). Specifically, the planning device 1 acquires task information from the input device 2, acquires accumulated information from the storage device 3, and acquires state information from each of the mobile robots 4.

Next, the first plan generation portion 11 sets the abstract state and the target logical expression based on the task information and the accumulated information (Step S102).

Furthermore, the first plan generation portion 11 generates operation sequence information to be executed by each mobile robot 4 in sub-task units so as to satisfy the target logical expression (Step S103).

The second plan generation portion 12 generates time-series control commands for each mobile robot 4 based on the operation sequence information (Step S104). Specifically, the second plan generation portion 12 generates time-series control commands indicating trajectories for the sub-tasks that are subject to trajectory generation, among the sub-tasks included in the operation sequence information.

For example, the second plan generation portion 12 generates time-series control commands in a “planning” sub-task that is established before the sub-task that is the subject of trajectory generation. The first sub-task being established before the second sub-task means that the first sub-task is set so that the first sub-task is executed before the second sub-task.

The control portion 14 generates control signals and transmits them to each mobile robot 4, and each mobile robot 4 operates based on the control signals (Step S105).

For sub-tasks that are not subject to trajectory generation by the second plan generation portion 12, the control portion 14 generates control signals according to the sub-tasks and transmits them to the mobile robots 4. For example, the accumulated information storage portion 31 may store the rules for generating control signals for each sub-task and for each type of mobile robot 4. The control portion 14 may then read the conversion rules from the accumulated information storage portion 31 according to the sub-task to be executed and the type of mobile robot 4 to be controlled, and generate control signals.

For the sub-tasks that are subject to trajectory generation by the second plan generation portion 12, the control portion 14 generates control signals according to the time-series control commands generated by the second plan generation portion 12 and transmits them to the mobile robot 4. For example, the control portion 14 may calculate the operating speed vector for each actuator to be controlled based on the trajectory generated by the second plan generation portion 12, and generate and transmit control signals according to the operating speed vector.

The control portion 14 may generate control signals and transmit them to the mobile robot 4 at each time step in the control.

After Step S105, the control system 100 terminates the process in FIG. 4.

The processing in Step S101 of FIG. 4 is explained using the case where the target task is a picking task. In Step S101 of FIG. 4, the planning device 1 obtains information from the input device 2, the storage device 3, and each of the mobile robots 4. The input device 2 transmits the target task to the planning device 1 based on input manipulation by the user or pre-databased information.

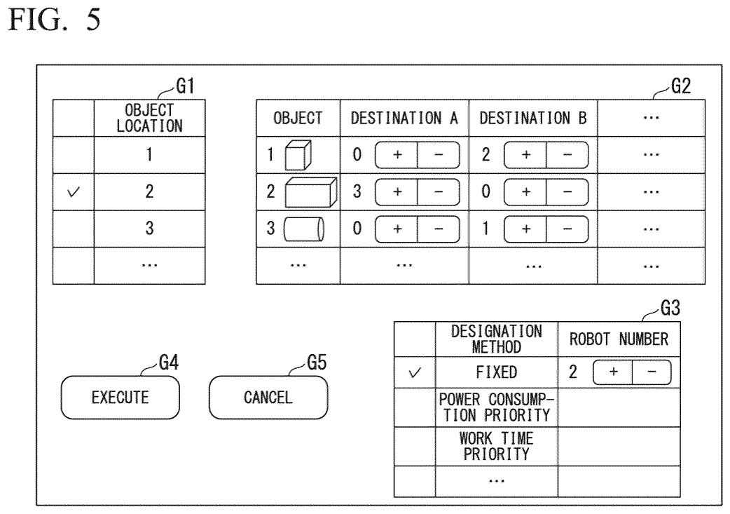

FIG. 5 shows an example display of a task input screen that receives input manipulations by the user when the target task is a picking task. The input device 2 may be equipped with a display device to show a task input screen. Alternatively, the display device may be configured as a separate device from the input device 2 to display the task input screen.

The task input screen shown in FIG. 5 forms part of the graphical user interface (GUI). For example, a touch panel may be used as the GUI, and a task input screen may be displayed on the touch panel. Alternatively, the GUI may be configured to include a display device that displays a task input screen and input devices such as a keyboard and mouse to receive user input manipulations on the task input screen.

In the example in FIG. 5, the location designation region G1 is a region for specifying the position where the object is placed.

The destination designation region G2 is a region for selecting the number of objects to be transported for each group of objects and for each destination. Groups of objects here may be, but are not limited to, groups for each type of object. The number of objects to be transported here is the number of objects to be transported.

The unit number designation region G3 is a region for specifying the number of mobile robots 4 to be used.

The execute button G4 is used to instruct the start of execution of the target task.

The cancel button G5 is used to instruct the user to cancel the execution of the target task.

The planning device 1 or input device 2 may read the location information of the object from the storage device 3 and display it in the location designation region G1. For example, the storage device 3 may store in advance environmental map information I7 that includes information on the location where the object is located. The task input portion 21 may then read the information on the location where the object is located from the environmental map information I7 and display it in the location designation region G1.

The planning device 1 or input device 2 may also read information on the destination of the object from the storage device 3 and display it in the destination designation region G2. For example, the storage device 3 may store in advance the object model information I6, which includes information indicating the number of conveyances for each group of objects and for each destination. The task input portion 21 may then read the number of conveyances for each group of objects and each destination from the object model information I6 and display it in the destination designation region G2.

Inputting the designation of the number of mobile robots 4 in the unit number designation region G3 corresponds to pre-setting for the process (Step S103) in which the first plan generation portion 11 generates the operation sequences to be executed by each mobile robot 4. Specifically, the first plan generation portion 11 generates an operation sequence for each of the number of mobile robots 4 specified in the unit number designation region G3.

In the example in FIG. 5, the unit number designation region G3 has a column for selecting the designation method. The user selects how to designate the number of mobile robots 4 in the designation method selection field.

In the “fixed” designation method, the user specifies the number of mobile robots 4 as an integer constant. In this case, the number of mobile robots 4 to be controlled by the planning device 1 is fixed to the specified number during the execution of the target task. In the example in FIG. 5, the number of mobile robots 4 to be controlled is specified as two.

In the “power consumption priority” designation method, the first plan generation portion 11 determines the number of mobile robots 4 to be controlled so that power consumption is kept as low as possible. In this case, the number of mobile robots 4 to be controlled may remain constant or vary during the execution of the target task.

In the “work time priority” designation method, the first plan generation portion 11 determines the number of mobile robots 4 to be controlled so that the time required to execute the target task is as short as possible. In this case, the number of mobile robots 4 to be controlled may remain constant or vary during the execution of the target task.

In addition to the information obtained by the task input portion 21, the planning device 1 may also obtain from the input device 2 environmental information obtained by the environmental information input portion 22.

The planning device 1 also retrieves the accumulated information or a portion thereof from the storage device 3.

The planning device 1 may obtain from each mobile robot 4 the position information of that mobile robot 4 and the state information of that mobile robot 4, such as the angle information of each joint of that mobile robot 4.

### (Example of Processing of First Plan Generation Portion)

The processing in Step S102 of FIG. 4 is explained using the case where the target task is a picking task. In Step S102 of FIG. 4, the first plan generation portion 11 generates the abstract state and the target logical expression.

The first plan generation portion 11 generates a target logical expression based on the task information obtained from the input device 2 and the accumulated information obtained from the accumulated information storage portion 31. The target logical expression is a logical expression that represents the target final state of achievement of the target task. The target logical expression may be expressed in the form of an abstract state. The first plan generation portion 11 may generate an equation as the target logical expression that combines the logical expression representing the target final state of achievement of the target task and the constraint conditions to be satisfied in the execution of the target task into a single logical expression.

To express the achieved state in a logical expression, the first plan generation portion 11 defines a proposition based on the abstract state specification information I1. For example, the first plan generation portion 11 defines the proposition “aᵢ” as the proposition “object i exists in region A, which is the target destination where it should ultimately be transported”. Here, i is an integer of i≥1 and represents an identification number that identifies the object.

The first plan generation portion 11 then generates a target logical expression using the defined proposition.

The first plan generation portion 11 may convert the target task described in natural language into a logical expression. In this case, various known methods can be used to convert target tasks described in natural language into logical expressions.

For example, consider the case where a picking task “The object (1) finally exists at the transfer destination (region A)” is set as the target task on the task input screen shown in FIG. 5. In this case, the first plan generation portion 11 may generate the target logical expression “⋄a₁” using the operator “⋄” corresponding to “eventually” in linear temporal logic (LTL) expression and the proposition “a₁” defined as the achieved state.

The operator “eventually” in the LTL expression is also referred to as “finally” or “future”.

Alternatively, the target logical expression may be expressed using any linear temporal logic operator other than the operator “⋄”. The operators of linear temporal logic here may include general logic operators.

For example, the first plan generation portion 11 may generate target logical expressions using conjunction “∧”, disjunction “∨”, negation “¬”, implication “⇒”, always “□”, next “∘”, or until “U”, or combinations thereof, in addition to or instead of eventually “⋄”. However, this is not limited to these options.

The temporal logic used by the first plan generation portion 11 to describe the target logical expression is not limited to linear temporal logic; for instance, the first plan generation portion 11 may describe the target logical expression based on MTL (Metric Temporal Logic) or STL (Signal Temporal Logic).

The first plan generation portion 11 may add constraint conditions to the target logical expression that must be satisfied in the execution of the target task. For example, the first plan generation portion 11 may generate a proposition indicating a constraint condition based on the constraint condition information I2.

The first plan generation portion 11 may generate the target logical expression in the form of a single logical expression that includes the constraint condition. Alternatively, the first plan generation portion may generate a logical expression indicating the constraint condition as a separate logical expression from the target logical expression, and generate an operation sequence that satisfies all of the target logical expression and constraint conditions.

For example, consider the case where the target task is a picking task with two mobile robots 4 (mobile robots 4a and 4b). In this case, the constraint condition “no interference (contact) between mobile robots 4” can be expressed as “□¬h”, where “h” is the proposition that the mobile robots 4 interfere with each other. Therefore, the first plan generation portion 11 may generate the logical expression “(⋄a₁)∧(□¬h)” as the target logical expression including a constraint condition.

Examples of constraint conditions when the target task is a picking task include, in addition to the above constraint condition, the constraint condition that “mobile robots 4 do not contact obstacles,” the constraint condition that “multiple mobile robots 4 do not pick the same object,” and the constraint condition that “objects do not contact each other. The first plan generation portion 11 may reflect any one or a combination of several of these constraint conditions in the target logical expression based on the constraint condition information I2.

Next, the processing in Step S103 of FIG. 4 shall be explained using the case where the target task is a picking task. In Step S103 of FIG. 4, the first plan generation portion 11 generates the order (sequence) of operations to be performed by each mobile robot so as to satisfy the target logical expression.

The control system 100 counts the time in time steps during the execution of the target task. In Step S103 or earlier, the number of time steps of the target task execution (the number of time steps from the start of the target task execution to its completion) is set. The number of time steps for the target task execution is also referred to as the target time step number.

The time range for the time steps when the control system 100 executes the target task is not limited to a specific time range.

The method of setting the target time step number is not limited to any particular method. For example, the user may set the target time step number by a user manipulation on the task input screen shown in FIG. 5. Alternatively, the first plan generation portion 11 may store in advance a calculation formula that outputs the target time step number upon receiving the input of accumulated information, and calculate the target time step number based on the accumulated information acquired in Step S101. Alternatively, the target time step number may be predetermined for each target task. Alternatively, a single target time step number may be determined in advance in common for all target tasks.

In the process of Step S103, the first plan generation portion 11 determines a combination of propositions representing the state at each time step so as to satisfy the target logical expression at the target time step number.

Let us take as an example the case where the aforementioned target task “object 1 finally exists in region A” is set. The first plan generation portion 11 uses the proposition “aᵢ, k”, in which the proposition “aᵢ” that “object i exists in region A” is extended to include the concept of time step. The proposition “aᵢ, k” is the proposition that “object i exists in region A at time step k”. Here, k is an integer with k≥1, and “time step k” indicates the k-th time step.

The first plan generation portion 11 also uses a target logical expression that has been extended to include the concept of time steps.

For example, if the target number of time steps is set to “3,” the first plan generation portion 11 generates the target logical expression “(⋄a₁)∧(□¬h)” in which the above target logical expression “(⋄a_{1, 3})∧(∧_{k=1, 2, 3}□¬hₖ)” is extended.

“∧_{k=1, 2, 3}□¬hₖ” indicates that the mobile robots 4 do not interfere with each other at any of time steps 1, 2 and 3. “(⋄a_{1, 3})∧(∧_{k=1, 2, 3}□¬hₖ)” expresses that “Object 1 exists in region A at time step 3, the final time step, and that the mobile robots 4 do not interfere with each other at any of time steps 1, 2 and 3”.

The following is an example of generating an operation sequence from a target logical expression.

The following is an example of a case where two mobile robots 4a and 4b perform the task of handling a single object. As above, the mobile robots 4a and 4b are also collectively referred to as mobile robots 4. The one object is also denoted as object 1.

The state vectors representing the positions of the two mobile robots 4a and 4b are denoted as “Xₐ” and “X_{b}”, respectively. The state vector representing the position of object 1 is denoted as “X₁”. These positions may be expressed in three-dimensional location information, i.e., three-dimensional coordinates. Alternatively, the location information may be expressed in a representation method other than three-dimensional coordinates, such as location information being expressed in two-dimensional coordinates when the height position can be ignored.

The dynamics of these state vectors, i.e., time variation (time evolution), shall be represented by an abstracted model. When considering two mobile robots 4a and 4b and one object as described above, the abstract model can be expressed, for example, as in Expression (1).

$$\begin{matrix}[ Expression 1 ] & \\ {( \begin{matrix}{X}_{a} \\ {X}_{b} \\ {X}_{1}\end{matrix} )}_{k + 1} = {I ( \begin{matrix}{X}_{a} \\ {X}_{b} \\ {X}_{1}\end{matrix} )}_{k} + ( \begin{matrix}I & 0 \\ 0 & I \\ {δ}_{a , 1} & {δ}_{b , 1}\end{matrix} ) ( \begin{matrix}{u}_{a} \\ {u}_{b}\end{matrix} ) & ( 1 )\end{matrix}$$

In Expression (1), k is an integer of k≥1 and represents a time step. Expression (1) represents the relationship between the values of Xₐ, X_{b}, and X₁ at time step k and the values of Xₐ, X_{b}, and X₁ at time step k+1.

uₐ and u_{b} denote control inputs for controlling the mobile robots 4a and 4b, respectively. Specifically, uₐ and u_{b} are vectors representing the amount of change per time step in the representative positions of mobile robots 4a and 4b, respectively.

“I” represents the unit matrix. “0” denotes a zero matrix.

δ_{j,1} (j=a, b) is a logical variable that becomes “1” when mobile robots 4a and 4b have each grasped the object 1, and “0” in other cases. A change in the value of the logical variable δ_{j,1} from “0” to “1” indicates that the mobile robot 4 picks the object 1. A change in the value of the logical variable δ_{j,1} from “1” to “0” indicates that the mobile robot 4 has placed the object 1. The first plan generation portion 11 may assign the picking or placing sub-task to the sub-task in the time step at which the value of the logical variable δ changes, among the sub-tasks in the operation sequence.

The correspondence between such operation sequences and logical variables is not limited thereto. The first plan generation portion 11 may also assign sub-tasks to the operation sequence according to changes in the values of logical variables for sub-tasks other than picking and placing, such as movement, recognition, and planning, or any of these, as described above.

As described above for the planning device 1, the first plan generation portion 11 generates an operation sequence by letting predefined sub-tasks serve as components in the operation sequence. Therefore, the location of the control targets exemplified by Xₐ and X_{b} in the abstract model illustrated in Expression (1) need only be indicated by the level of detail of the control target performing the sub-task, and additional detailed location information need not be specified in the abstract model and operation sequence.

In the example of Expression (1), the sub-tasks, such as picking and placing, are shown as processes performed by the mobile robots 4a and 4b. Therefore, in Expression (1), the vectors Xₐ and X_{b} representing the positions of the mobile robots 4a and 4b as the positions to be controlled are indicated.

In this case, a representative position such as the center of gravity or center position of the mobile robot 4 can be used as the position of the mobile robot 4.

As mentioned above, when sub-tasks are represented as processes to be performed by the mobile robots 4a and 4b, the individual location information of each part of the mobile robot 4, such as the movement portion 42 of the mobile robot 4 and the paw of the robot arm portion 41, need not be shown in the abstract model and the operation sequence.

Operation plans for each part of the mobile robot 4 that are more detailed than the sub-task units may be generated by the second plan generation portion, as described below.

Here the relationship between propositions and logical variables shall be explained.

Let the fact that mobile robot 4 picks object i be represented by the proposition “pᵢ”, which means “mobile robot 4 exists in the region Hᵢ where object i can be picked”. Here, i is a positive integer indicating the identification number of the object.

Let the proposition pᵢ be represented, for example, by the inequality shown in Expression (2).

$$\begin{matrix}[ Expression 2 ] & \\ d \leq {H}_{i \_ d} & ( 2 )\end{matrix}$$

d represents the distance between the mobile robot 4 and object i. H_{i_d} represents the distance between the object i and the boundary of region Hᵢ. The value of H_{i_d} is not uniquely determined unless the region Hᵢ is a circular region centered on the location of object i. Let us assume that the distance between the intersection of a half line drawn from the position of the object i to pass through the position of the mobile robot 4 and the boundary of the region Hᵢ and the position of object i has been obtained and is represented by H_{i_d}.

Expression (2) can be transformed as in Expression (3).

$$\begin{matrix}[ Expression 3 ] & \\ 0 \leq {H}_{i \_ d} - d & ( 3 )\end{matrix}$$

Assume that the minimum (lower limit) Amin and the maximum (upper limit) Δₘₐₓ of the possible values of “H_{i_d}−d” on the right side of Expression (3) are defined. These values should be set sufficiently small and sufficiently large, but may be set according to the actual environment to improve stability and speed of solving. For example, d becomes larger as the mobile robot 4 moves away from object i, so the value on the right side of Expression (3) becomes a large negative value. Accordingly, the minimum value Δₘᵢₙ can be, for example, the distance between the two most distant points in the space (region) subject to the calculation, with a minus sign. On the other hand, the maximum value Δₘₐₓ is Δₘₐₓ=H_{i_d} when d=0, i.e., when the mobile robot 4 is in contact with the object i.

By introducing the logical variable δ_{j, i}, which takes the value “0” or “1”, and denoting the value of the proposition “pᵢ” in the position vector “Xⱼ” of the mobile robot 4 as “Xⱼ[pᵢ]”, it can be expressed as in Expression (4).

$$\begin{matrix}[ Expression 4 ] & \\ {δ}_{j , i} = {X}_{j} [ {p}_{i} ] ∈ \{ 0 , 1 \} & ( 4 )\end{matrix}$$

The value is “1” if the proposition or logical expression is true, and “0” if it is false.

Using the logical variable δ_{j, i}, the condition that the inequality “0≤H_{i_d}−d” holds can be expressed, for example, by a linear inequality such as Expression (5).

$$\begin{matrix}[ Expression 5 ] & \\ {Δ}_{min} ( 1 - {δ}_{j , i} ) \leq {H}_{i \_ d} - d \leq {Δ}_{max} {δ}_{j , i} + ( {δ}_{j , i} - 1 ) ϵ & ( 5 )\end{matrix}$$

ε is a sufficiently small number. This Expression (5) implies that the inequality “0≤H_{i_d}−d” is satisfied if the value of the logical variable δ_{j, i} is “1”, regardless of the value of Δₘᵢₙ and ε. In this case, the position Xⱼ of the mobile robot falls within the pickable range Hᵢ and satisfies the proposition pᵢ. Therefore, the determination of whether or not proposition pᵢ is satisfied can be formulated as a simple determination that the value of the logical variable δ_{j, i} is “0” or “1”. In other words, the determination of whether or not the proposition “pᵢ” is satisfied can be expressed as a logical condition relation as in Expression (6).

$$\begin{matrix}[ Expression 6 ] & \\ {δ}_{j , i} = {X}_{j} [ {p}_{i} ] = 1 \to {X}_{j} ∈ {H}_{i} & ( 6 )\end{matrix}$$

In other words, when the value of the logical variable δ_{j, i} is “1”, the mobile robot 4 is in the pickable region Hᵢ, in other words, it is picking. Thus, whether or not the conditional expression in Expression (6) holds can be expressed by the value of the logical variable (0 or 1). Note that the present invention is not limited to the method of expressing logical relations by transforming them into linear inequalities by introducing logical variables, since there are other methods other than the above Expression (5). For example, the method called the big-M method, which uses a sufficiently large value M instead of a sufficiently small number & as in Expression (5), is another typical approach.

Similarly, the proposition “a_{i, k}” for object 1, “object 1 exists in region A at the final time step 3,” is expressed as in Expression (7), using the state vector “X₁” of object 1, as in Expression (6), when the logical variable θ₁(1:3) at time step 3 is introduced.

$$\begin{matrix}[ Expression 7 ] & \\ {θ}_{1} ( 1 : 3 ) = {X}_{1} [ {a}_{i 1 , 3} ] = 1 \to {X}_{1} ∈ A & ( 7 )\end{matrix}$$

Therefore, the target logical expression “(⋄a_{1, 3})” is valid when the value of the logical variable θ₁(1:3) expressed in the Expression (7) is “1”.

Next, the proposition “h”, i.e., the target logical expression “Δₖ₌1, 2, 3□¬hₖ”, which indicates “no interference between mobile robots 4 in any of time steps 1, 2 and 3” shall be explained. The fact that the position vector “Xₐ” of one mobile robot 4a enters the interference region “H_{b}” based on the position vector “X_{b}” of the other mobile robot 4b can be expressed by the value of the logical variable ηₐ being “1” as in Expression (8).

$$\begin{matrix}[ Expression 8 ] & \\ {η}_{a} = {X}_{a} [ h ] = 1 ↔ {X}_{a} ∈ {H}_{b} & ( 8 )\end{matrix}$$

An interference region can be said to be a region of possible interference (contact or collision). In the above example, the fact that the position of mobile robot 4a, indicated by position vector Xₐ, falls within the interference region H_{b} indicates the potential for interference between the mobile robot 4a and mobile robot 4b.

Similar to the case of Expression (8), the position vector “X_{b}” of the mobile robot 4b can be expressed as in Expression (9) using the logical variable η_{b} and the interference region “Hₐ” based on the position vector “Xₐ” of the mobile robot 4a.

$$\begin{matrix}[ Expression 9 ] & \\ {η}_{b} = {X}_{b} [ h ] = 1 ↔ {X}_{b} ∈ {H}_{a} & ( 9 )\end{matrix}$$

is expressed. Here, Expressions (8) and (9) differ from expressions (6) and (7) in that the converse holds. That is, the left-hand logical variable is true (1) not only when the right-hand set relation holds but also when the right-hand set relation holds, the left-hand logical variable becomes true (1).

The proposition “h” is equivalent to the fact that at any time step (i.e., always “□”) Expressions (8) and (9) hold.

The condition that the logical expressions such as Expressions (8) and (9) are independent of the time step and independent of the sequential relationship such as the assumed operation being performed can be used not only as a condition for logical variables for the target logical expression to be valid, but also as a direct constraint condition for continuous variables, such as the position vectors “Xₐ” and “X_{b}”. An example of this case is the constraint condition in Expression (10).

$$\begin{matrix}[ Expression 10 ] & \\ {X}_{a} \neq {X}_{b} , {X}_{a x} < {X}_{b x} & ( 10 )\end{matrix}$$

“Xₐₓ” and “X_{bx}” represent the x-coordinates of mobile robots 4a and 4b, respectively. “Xₐₓ<X_{bx}” is a specific example of “Xₐ≠X_{b}”. For example, if Expression (10) holds, Hₐ and H_{b} are set so that the proposition h, “No interference between the mobile robots 4 at any of time steps 1, 2, and 3,” holds.

However, the conditional expression shown in Expression (10) is illustrative and is not limited thereto.

From the above, it is sufficient to set either Expressions (8) and (9), which use logical variables, or Expression (10), which is a constraint condition on continuous variables, as the constraint condition represented by the target logical expression “Δ_{k=1, 2, 3}□¬hₖ”.

The above formulation regarding conditions is an example and is not limited thereto.

From the above, the operation sequence that satisfies the target logical expression is obtained by minimizing the values of the state vectors “Xₐ”, “X_{b}” and “X₁” and the logic variable δ_{j, i} at each time step so as to satisfy Expressions (6) and (7), which represent the constraint conditions, and Expressions (8) and (9) or (10), and the squared sum of the norms of the control inputs uₐ and u_{b} in Expression (1).

The conditions to be satisfied are collectively expressed in terms of Φ, with Φ being expressed as in Expression (11) using the sum of squares of the control input uₖ at each of the time steps k.

$$\begin{matrix}[ Expression 11 ] & \\ {arg min}_{u} ( {\sum }_{k = 0}^{T} ( {‖ {u}_{k} ‖}^{2} ) ) s . t . ϕ = True & ( 11 )\end{matrix}$$

argmin is a function that outputs the parameter value that minimizes the value of a given expression as a function value. In the case of Expression (11), argmin outputs the value of parameter u such that the value of (Σₖ₌₀^{T}(∥uₖ∥²)) is minimized.

Solving Expression (11) yields an operation sequence that satisfies the target logical expression. An optimization problem in which integer variables (e.g., logical variables) and real-valued variables are mixed, as in Expression (11), is called a mixed integer optimization problem or mixed integer programing problem. Mixed integer programming problem solving is collectively referred to as mixed integer programming (MIP).

The method by which the first plan generation portion 11 solves the mixed integer programming problem illustrated in Expression (11) is not limited to any particular method. For example, the first plan generation portion 11 may solve the mixed integer programming problem using known mixed integer programming methods.

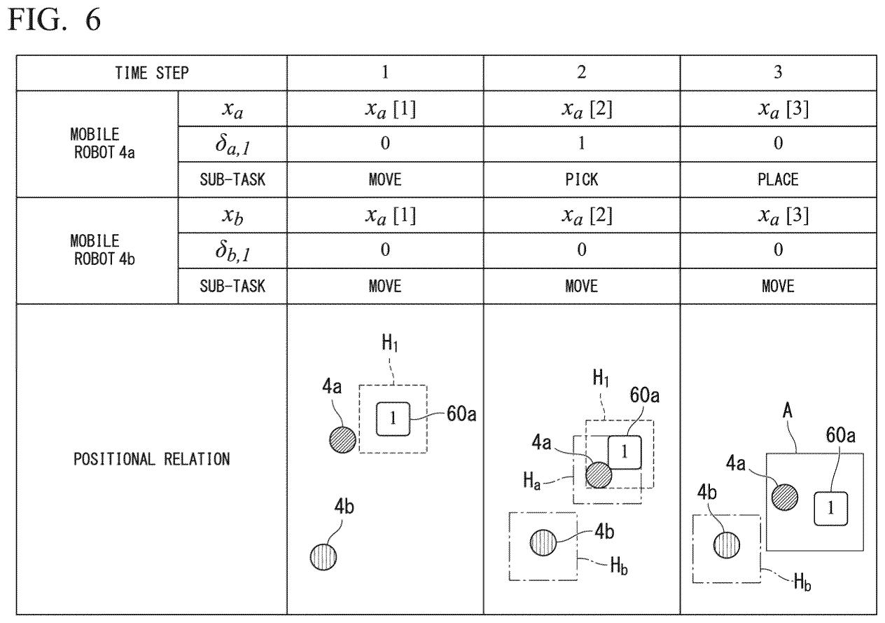

FIG. 6 is a diagram that shows an example of variable values calculated by the first plan generation portion 11.

FIG. 6 shows the values of state vectors Xₐ, X_{b}, and logical variable δ_{j, i} for each time step, which are calculated by the first plan generation portion 11 as the solution satisfying the target logical expression “(⋄a_{1, 3})∧(∧_{k=1, 2, 3}□¬hₖ)” by solving the mixed integer programming problem shown in Expression (11).

FIG. 6 also shows examples of the sub-tasks that the first plan generation portion 11 determines for each of the mobile robots 4a and 4b at each time step.

FIG. 6 also shows the positional relationship of the mobile robot 4a, the mobile robot 4b, and the object 60a at each time step based on the operation sequence generated by the first plan generation portion 11. The object 60A is also denoted as object 1.

The values of the state vectors Xₐ and X_{b} represent the positions of the mobile robots 4a and 4b, respectively. The value of the logical variable δ_{j, i} indicates that the mobile robot 4j (j=a or b) is capable of picking the object i (i=1 in the example in FIG. 6). The mobile robot 4 located in the region where the object can be picked shall pick the object.

The position Xₐ of the mobile robot 4a at time step k (k=1, 2, 3) is denoted Xₐ[k] The position X_{b} of mobile robot 4b at time step k is denoted as X_{b}[k] The logical variable δ_{j, i} take on the value of 0 or 1.

The region where the mobile robot 4 can pick the object 1 is denoted as H₁. The region to which the object 1 is transported is denoted as region A. Also shown in FIG. 6 are interference regions Hₐ and H_{b}.

FIG. 6 shows an example of an operation sequence in which the object 1 is placed in the region A at time step 3 as a condition for satisfying Expression (7). An example of this operation sequence is described below.

In time step 1, neither of the mobile robots 4a nor 4b is picking the object 1. This is indicated by the fact that both the logical variables δ_{a,1} and δ_{b,1} are zero. In order for the object 1 to be placed in region A, it must first be picked by one of the mobile robots 4a or 4b.

In time step 2, the logical variable δ_{a,1} of the mobile robot 4a changes from 0 to 1 at position Xₐ[2]. This indicates from Expression (6) that the mobile robot 4a has entered the region H₁ where the object 1 can be picked at position Xₐ[2]. In this case, the mobile robot 4a picks the object 1. The first plan generation portion 11 assigns “picking” as the sub-task of the mobile robot 4a in time step 2.

In time step 3, the logical variable δ_{a,1} of the mobile robot 4a changes from 1 to 0 at position Xₐ[2]. At this time, the value of the logical variable θ₁(1:3) is assumed to be 1. Then, from expressions (6) and (7), the mobile robot 4a places the object 1 and so the object 1 is in region A. The first plan generation portion 11 assigns “place” as the sub-task of the mobile robot 4a in time step 3.

With regard to the proposition “h,” which indicates that “the mobile robots 4a and 4b do not interfere with each other”, from the validity of expressions (8) and (9), or Expression (10), it can be inferred that neither mobile robot 4a nor 4b has entered the interference regions Hₐ and H_{b} of the other, and so proposition “h” holds true.

In the example in FIG. 6, the first plan generation portion 11 assigns movement as a sub-task for the mobile robot 4a in time step 1 and as a sub-task for the mobile robot 4b in each of time steps 1 through 3, respectively.

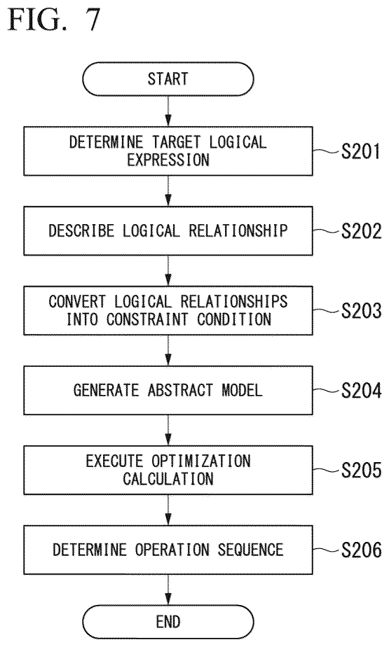

FIG. 7 is a flowchart showing an example of a processing procedure in which the first plan generation portion 11 generates an operation sequence from a target logical expression.

In the process shown in FIG. 7, the first plan generation portion 11 determines the target logical expression based on the target task and constraint condition (Step S201). Step S201 corresponds to Step S102 in FIG. 4.

Next, the first plan generation portion 11 describes the logical relationship to satisfy the target logical expression based on the target logical expression (Step S202). To describe a logical relationship here is to generate information indicating the logical relationship. The first plan generation portion 11 describes the logical relationship necessary to satisfy the target logical expression, for example, using relationships such as the inequalities described above.

The first plan generation portion 11 then converts the logical relationships into constraint conditions (Step S203). For example, the first plan generation portion 11 converts logical relationships expressed as inequalities, etc., into constraint conditions expressed as linear inequalities with logical variables.

The process in Step S203 corresponds to the introduction of the logical variable δ_{j, i} and the generation of the constraint condition expressed in Expression (5) in the example above.

Then, the first plan generation portion 11 expresses the state of the target system using logical variables and generates an abstract model representing the dynamics (Step S204). The process in Step S204 corresponds to the generation of the model expressed in Expression (1) in the example above.

Next, the first plan generation portion 11 optimizes the abstract model under the specified time step and to satisfy the constraint condition (Step S205). The process in Step S205 corresponds to finding a solution to the optimization problem shown in Expression (11) in the example above.

The first plan generation portion 11 then determines the operation sequence based on the state of each time step obtained by optimization and the values of the logical variables (Step S206).

This is determined by relating the change in the value of the logical variable δ_{j, i} to the operation sequence, as in the example in FIG. 6.

In other words, the process in Step S206 involves converting the relationship between quantities, i.e., the target value of the continuous state and the target value of the logical variable for each time step, obtained by the optimization calculation in Step S205, into information in the form of an operation sequence.

A more appropriate trajectory can be obtained by having the second plan generation portion 12 recalculate the trajectory. For example, the first plan generation portion 11 can reduce the amount of calculation and shorten the computation time by handling the minimum continuous values in order to determine (optimize) the sequence order. In the second plan generation portion, it becomes possible to achieve high-precision or sophisticated control by seeking trajectories with higher time steps and spatial resolution for specific sequences.

In the example above, the assignment of the sub-task “pick” in the case where the value of the logical variable δ_{a,1} changes from 0 to 1 is an example of the transformation in this case. The assignment of the sub-task “place” when the value of the logical variable δ_{a,1} changes from 1 to 0 is also an example of transformation in this case.

The above-mentioned correspondence between changes in the values of the logical variable δ_{j, i} and the sub-tasks of picking and placing may be stored by the accumulated information storage portion 31 as a definition of sub-tasks, for example, in the form of rule-based transformation rules, as part of the sub-task information I4.

Steps S202 to S206 correspond to an example of the procedure for the first plan generation portion 11 to generate the order of operations in Step S103 of FIG. 4.

After Step S206, the first plan generation portion 11 completes the process shown in FIG. 7.

The first plan generation portion 11 may generate multiple candidates for the target logical expression and select the feasible candidate. In the following, candidate target logical expressions are denoted as “Φᵢ”. Here i is an integer with i≥1 and represents an identification number that identifies a candidate target logical expression. Each of the candidate target logical expressions may be described in the form of a target logical expression. Candidates for target logical expressions are also referred to simply as candidates.

The first plan generation portion 11 may generate a tentative target logical expression, expressed in the form of a logical OR of multiple candidates. For example, the two candidates may be denoted as Φ1 and Φ2, and the first plan generation portion 11 may generate a provisional target logical expression “Φ1 V Φ2”.

For example, “⋄a_{1, 3}” indicates only the condition at time step 3, and is optional (Don't Care) for time steps 1 and 2. Therefore, all of
(1) If object 1 is in region A at time step 3 and object 1 is not in region A at either of time steps 1 and 2 (¬a_{1, 1}∧¬a_{1, 2}∧a_{1, 3}),
(2) If object 1 is in region A at either of time steps 2 and 3 and object 1 is not in region A in time step 1 (¬a_{1, 1}∧a_{1, 2}∧a_{1, 3}),
(3) If object 1 is present in region A in either of time steps 1 and 3 and object 1 is not present in region A in time step 2 (a_{1, 1}∧¬a_{1, 2}∧a_{1, 3}),
(4) If object 1 is in region A in any of time steps S1 to 3 (a_{1, 1}∧a_{1, 2}∧a_{1, 3}) satisfy “⋄a_{1, 3}”.

The candidates Φ1 to Φ4 according to conditions (1) to (4) are expressed as follows.

$$Φ 1 = ( ¬ {a}_{1 , 1} ∧ ¬ {a}_{1 , 2} ∧ {a}_{1 , 3} ) ∧ ( {∧}_{k = 1 , 2 , 3} □ ¬ {h}_{k} )$$

$$Φ2 = ( ¬ {a}_{1 , 1} ∧ ¬ {a}_{1 , 2} ∧ {a}_{1 , 3} ) ∧ ( {∧}_{k = 1 , 2 , 3} □ ¬ {h}_{k} )$$

$$Φ3 = ( {a}_{1 , 1} ∧ ¬ {a}_{1 , 2} ∧ {a}_{1 , 3} ) ∧ ( {∧}_{k = 1 , 2 , 3} □ ¬ {h}_{k} )$$

$$Φ4 = ( {a}_{1 , 1} ∧ {a}_{1 , 2} ∧ {a}_{1 , 3} ) ∧ ( {∧}_{k = 1 , 2 , 3} □ ¬ {h}_{k} )$$

Thus, the first plan generation portion 11 may generate a provisional target logical expression containing multiple candidates and determine the feasibility of each candidate by referring to the operation limit information I3 for each candidate. The first plan generation portion 11 may then generate the final target logical expression by excluding from the tentative target logical expression the candidates that are determined to be infeasible.

For example, the first plan generation portion 11 calculates the distance that the mobile robot 4 can travel per time step with reference to the operation limit information I3. The first plan generation portion 11 calculates the distance from the current position of the mobile robot 4 (position at the start of the target task) to the position of the object based on the position information of the mobile robot 4 and the environmental map information I7. The first plan generation portion 11 calculates the number of time steps required for the mobile robot 4 to reach the object by dividing the distance from the current position of the mobile robot 4 to the position of the object by the distance the mobile robot 4 can travel per time step.

The first plan generation portion 11 calculates the distance from the object's location to the object's transport destination position based on the environmental map information I7. The distance from the object's position to the object's transport destination position is divided by the distance that the mobile robot 4 can travel per time step, and the number of time steps required for the mobile robot 4 to transport the object is calculated.

If the number of time steps required for the operation of the robot arm portion 41 cannot be ignored, the first plan generation portion 11 may calculate the number of time steps required for the robot arm portion 41 to reach the object to be picked. For example, the first plan generation portion 11 may calculate the number of time steps required for the robot arm portion 41 to reach the object to be picked based on the distance the robot arm portion of the mobile robot can travel per time step and the information obtained from the environmental information input portion 22.

The first plan generation portion 11 can use the calculation results to determine the feasibility of each candidate. Specifically, the first plan generation portion 11 can determine whether the candidates can be satisfied if the target task is started from the current position of the mobile robot 4. Here, being able to satisfy a candidate means that there exists a method of controlling the mobile robot 4 such that the logical expression describing the candidate is true.

Using the case of two mobile robots 4 executing a picking task without interfering with each other as an example, the process by which the first plan generation portion 11 generates an operation sequence for each mobile robot 4 using the above target logical expression shall be described. The two mobile robots 4 are denoted here as the mobile robot 4a and the mobile robot 4b.

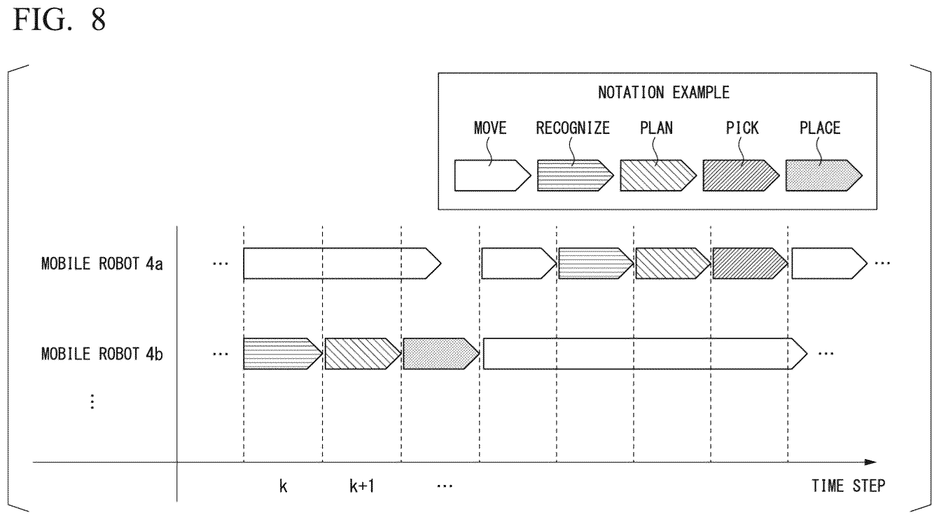

FIG. 8 is a diagram showing an example of the operation sequence assuming a case in which the object transported by the mobile robot 4b is picked by the mobile robot 4a and transported to another location. The horizontal axis in FIG. 8 represents time in time steps. In the example in FIG. 8, the operation sequence for each of the mobile robots 4a and 4b is represented in sub-task units.

Sub-tasks are operations that are constituent elements of an operation sequence. Sub-tasks are executed independently of other sub-tasks. Specifically, the control portion 14 generates control signals according to the sub-tasks, and each of the mobile robots 4 operates according to the control signals generated by the control portion 14. The control portion 14 can generate control signals to cause the mobile robot 4 to perform the sub-task to be executed, without reference to other sub-tasks. The mobile robot 4 can execute the sub-task to be executed based on the control signals from the control portion 14, and does not need to refer to control signals for other sub-tasks to execute the sub-task to be executed.

The sub-tasks are also specified as operations for each mobile robot 4. However, multiple mobile robots 4 can be made to work together by having each of the multiple mobile robots 4 perform a sub-task.

In FIG. 8, five types of sub-tasks are shown: “move,” “recognize,” “plan,” “pick,” and “place”. The “move” and “recognize” sub-tasks are the same as described above. The “pick” sub-task is the same as the “retrieve” sub-task described above.

In “plan,” the second plan generation portion 12 generates time-series control commands for the movement portion 42 and the robot arm portion 41.

However, sub-tasks are not limited thereto.

In the example in FIG. 8, a sub-task is associated with a time step. Specifically, for each of the “recognize”, “plan”, “pick” and “place” sub-steps, the mobile robot 4 executes one sub-step within the time of one time step.

The operation sequence generated and output by the first plan generation portion 11 in the example in FIG. 8 reflects the conditions including time steps based on the constraint condition information I2, the operation limit information I3, and the sub-task information I4. These conditions include conditions between sub-tasks.

A condition that includes a time step here may be a temporal condition identified using a time step. Examples of conditions that include time steps include, but are not limited to, the condition that a task can be started at a time after a certain time step, and the condition that a task cannot be performed until a certain time step. In the example in FIG. 8, “plan” can be executed in the time step after the time step in which “recognize” is executed. In addition, “pick” and “place” can be executed after the time step in which “plan” is executed.

The conditions involving time steps may be expressed using temporal logic and reflected in the mobile robot 4. The order of execution of the process among multiple mobile robots 4 may be represented using time steps.

The condition between sub-tasks here may be a condition that specifies the order in which the sub-tasks are to be executed. In the example in FIG. 8, “plan” can be performed after “recognize” is executed. In addition, “pick” and “place” can be executed after “plan” is executed.

In the example in FIG. 8, the processing load during the execution of “move” is assumed to be small for each sub-task. It is also assumed that the sub-task information I4 includes information on the processing power required to execute each sub-task, and shows that the processing load is low during the movement of the mobile robot 4a (i.e., during the execution of “move”).

The planning device 1 is configured as a separate processing device from the mobile robot 4, for example, an edge server or a cloud server. In particular, the planning device 1 is configured as a common processing device for multiple mobile robots, such as mobile robots 4a, 4b, and so on.

Therefore, the first plan generation portion 11 generates the operation sequence so that during the execution of “move” by one mobile robot 4, sub-tasks with a higher processing load are assigned to other mobile robots 4.

For example, according to the operation sequence shown in FIG. 8, the planning device 1 executes “recognize” and “plan” of the mobile robot 4b during the execution of “move” of the mobile robot 4a. The planning device 1 also executes “recognize” and “plan” of the mobile robot 4a during the execution of “move” of the mobile robot 4b.

Thus, based on the standard processing load for each sub-task shown in the sub-task information I4, the first plan generation portion 11, in a time step of assigning a sub-task with a relatively high processing load to one mobile robot 4, assigns a sub-task with a relatively low processing load to another mobile robot 4.

This can avoid the concentration of processing with a high processing load in one time step in the processing of the planning device 1. In addition, the resources of the planning device 1 can be effectively utilized in that sub-tasks with relatively high processing load and sub-tasks with relatively low processing load are assigned to the same time step.

The operation sequence shown in FIG. 8 also takes into account the order of sub-tasks, such as the mobile robot 4 executing picking and then moving, the mobile robot 4 executing placing and then moving, and so on.

In the example in FIG. 8, the constraint condition indicated by the constraint condition information I2 includes the constraint condition that the four mobile robots do not interfere with each other. Accordingly, the first plan generation portion 11 determines the operation sequence so that the mobile robot 4a moves toward the object after the mobile robot 4b performs the place sub-task.

In the example in FIG. 8, all time steps have the same time duration, but it is not limited thereto. For example, the time durations for the execution of the “recognize,” “plan,” “grasp,” and “place” sub-tasks are the same, but the time durations may be different for each sub-task. The time duration of one step portion of a time step may be different for each mobile robot 4, depending on the type of mobile robot 4, individual differences, or operating environment.

The first plan generation portion 11 may also update the operation sequence based on the processing results of the second plan generation portion 12 described below. In this case, the first plan generation portion 11 may modify the order of the operation sequence or the number of time steps required, or both.

For example, the second plan generation portion 12 may perform the optimization process based on the results of the first and second plan generation portions 11 and 12. In this case, the optimization process may be, but is not limited to, for example, reducing power consumption or shortening the time required to execute the target task.

If the optimization process fails to produce the target result, the first plan generation portion 11 may update the operation sequence. For example, the first plan generation portion 11 may add a predetermined number (an integer equal to or greater than 1) to the target number of time steps and regenerate the operation sequence.

Next, the relationship between the process performed by the first plan generation portion 11 and the unit number designation region G3 in FIG. 5 shall be explained.

FIG. 8 shows an example of the operation sequence when the number of mobile robot 4 is set to 2 as a fixed value. The sub-task information I4 may include information indicating the power consumption of each sub-task as the processing power required to execute each sub-task. The second plan generation portion 12 can estimate the power consumption required to execute the target task using such information and a target logical expression that includes the concept of time steps.

The first plan generation portion 11 may also optimize the number of mobile robots 4 in operation based on the work time. For example, the first plan generation portion 11 may determine the number of mobile robots 4 to be used to execute the target task and generate an operation sequence for each mobile robot 4 so that the target number of time steps can be achieved. In order for the first plan generation portion 11 to determine the number of mobile robots 4 to be used to execute the target task, it may refer to information such as the standard required processing time and processing load for each sub-task as indicated in the sub-task information I4.

If “power consumption priority” is selected in the unit number designation region G3 in FIG. 5, the first plan generation portion 11 sets or changes the number of mobile robots used to execute the target task and generates the operation sequence, as described above. The second plan generation portion 12 then performs the optimization process to achieve smaller power consumption, using the function for estimating power consumption as the evaluation function. By repeating the process of the first plan generation portion 11 and the second plan generation portion 12, the number of mobile robots 4 and the operation sequence with the minimum power consumption can be determined.

If “work time priority” is selected in the unit number designation region G3, the first plan generation portion 11 sets or changes the number of mobile robots used to execute the target task, sets the target number of time steps, and generates the operation sequence, as described above. The second plan generation portion 12 generates time-series control commands for each of the mobile robots 4 based on the operation sequences generated by the first plan generation portion 11.

As described below with reference to FIG. 11, the second plan generation portion 12 may break down the sub-tasks included in the operation sequence into more detailed sub-tasks. The first plan generation portion 11 and the second plan generation portion 12 may then optimize the number of time steps for target task execution based on the subdivided sub-tasks.

By repeating the process of the first plan generation portion 11 and the second plan generation portion 12, the number of mobile robots and the operation sequence with the minimum number of target time steps can be determined.

However, the method for determining the number of mobile robots 4 is not limited thereto.

### (Example of Process of Second Plan Generation Portion)

The processing in Step S104 of FIG. 4 shall be explained using the case where the target task is a picking task. In Step S104 of FIG. 4, the second plan generation portion 12 generates time-series control commands for the time-series operation of each mobile robot 4.

The second plan generation portion 12 generates time-series control commands using a target logical expression including the time step concept described above, the operation sequence output by the first plan generation portion 11, and information obtained from the accumulated information storage portion 31.

In the operation sequence in the case of the picking task in the example in FIG. 8, the second plan generation portion 12 performs processing in the “plan” sub-task. In other words, the timing of the processing by the second plan generation portion 12 is defined in time step units by the first plan generation portion.

The second plan generation portion 12 generates the time-series control commands (time-series data of control commands) necessary for the operation of the mobile robot 4 in the operation sequence output by the first plan generation portion 11. For example, in the case of the picking task shown in FIG. 8, the “pick” and “place” sub-tasks are applicable. Therefore, in the operation sequence shown in FIG. 8, the aforementioned “pick” and “place” are always set as processes after the “plan” sub-task. This constraint condition may be included in the constraint condition information I2.

The second plan generation portion 12 generates an abstract model based on the abstract model information I5 in order to generate time-series control commands (time-series data of control commands). Here, the abstract model information I5 records the information necessary to generate an abstract model for each type of target task. For example, if the target task is a picking task, information such as the location and number of objects and the location of the destination are recorded in the abstract model information I5 in a generic format that does not specify the number of mobile robots 4, and the like.

The second plan generation portion 12 then generates an abstract model “Σ” by reflecting information in the actual work space in generic format information recorded in the abstract model information I5. Examples of information to be reflected in the generic format information include information obtained from the environmental information input portion 22, such as the location of objects in the actual environment, the number of objects, and the location of the destination, etc., and the number of mobile robots 4 used to perform the target task, determined based on the input to the task input portion 21.

The data that the second plan generation portion 12 obtains from the environmental information input portion 22 may be data input by cameras or sensors installed in the task execution area (work space) or mounted on the mobile robot 4, or by other means. The abstract model information I5 also includes information indicating the conditions for switching dynamics in the hybrid system, as described above.

An example of a condition for switching dynamics in a hybrid system is the condition “whether or not the robot arm portion 41 of the mobile robot 4 is picking the object i”. In the picking task, when the robot arm portion 41 picks the object i, the object i also moves when the mobile robot 4 moves. On the other hand, if the robot arm portion 41 does not pick the object i, the object i does not move even if the mobile robot 4 moves.

However, conditions for switching dynamics in hybrid systems are not limited thereto.

The switching of dynamics may be represented by logical variables so that the second plan generation portion 12 can design the operation of the mobile robot 4 according to the switching of dynamics. For example, if the target task is picking, whether or not the robot arm portion 41 is picking the object i may be abstractly represented by the logical variable “δᵢ”.

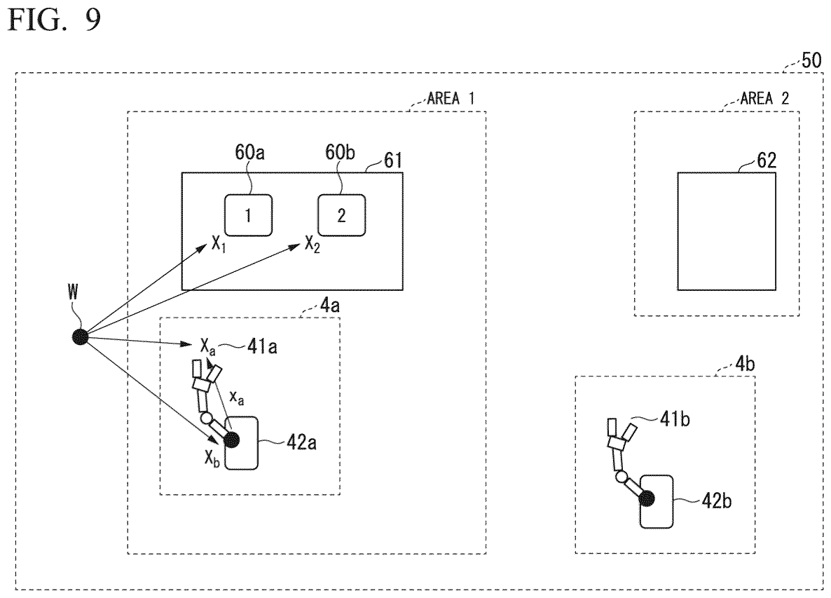

FIG. 9 shows an example of the abstract state setting space 50 used by the first and second plan generation portions 11 and 12 based on the abstract state specification information I1. The abstract state setting space here is the region (computational region) that contains the abstract state settings. In the case of the example in FIG. 9, the abstract state is set to whether or not the robot arm portion 41 is picking the object i. The abstract state setting space 50 may be different from the actual work space. For example, the first plan generation portion 11 and the second plan generation portion 12 may use the same coordinates as the coordinates in the work space as the coordinates in the abstract state setting space 50, or they may use coordinates different from those in the work space.

In the abstract state setting space 50 shown in FIG. 9, there are two mobile robots 4a and 4b, a work table 61 in region 1 where two objects 60a and 60b (object 1 and object 2) exist, and a work table 62 in area 2 where the objects are supposed to be transported.

Suppose that the recognition processing portion 13 is able to recognize the respective state quantities, such as the range of existence of the work table 61 in the abstract state setting space 50, the position and orientation of each of object 1 and object 2, and the range of existence of the work table 62 to which the objects are transported. The recognition processing portion 13 obtains the above information, for example, based on the environmental information obtained from the environmental information input portion 22 and the position information of each mobile robot 4 contained in the state quantities obtained from the mobile robots 4a and 4b.

The recognition processing portion 13 can represent the state of each recognized element using a coordinate system with the origin at the reference point W, which is set within the abstract state setting space 50. If coordinates different from those in the work space are used as coordinates in the abstract state setting space 50, information for converting the coordinates between the abstract state setting space 50 and the work space may be included in the environmental map information I7.

The second plan generation portion 12 obtains information on the recognition results by the recognition processing portion 13. For example, the second plan generation portion 12 obtains the position vectors “X₁” and “X₂” of the respective centers of gravity of object 1 and object 2 from the recognition processing portion 13 as the position orientation (position and orientation) of object 1 and object 2.

Here is an example of the representation of the dynamics of the mobile robot 4, using the mobile robot 4a in FIG. 9 as an example.

In the example in FIG. 9, the reference position vector of the movement portion 42a of the mobile robot 4a is denoted as vector “X_{b}”, while the position vector of the paw of the robot arm portion 41a is denoted as vector “Xₐ”.

The reference position vector here is a vector that indicates the position defined as the reference position. For example, the reference position vector of the movement portion 42a is a vector indicating the reference position set for the movement portion 42a. The vector X_{b} is also referred to as the state X_{b}. The vector Xₐ is also referred to as the state Xₐ.

The movement portion 42b and the robot arm portion 41b of the mobile robot 4b can be represented similarly. For ease of viewing the figure, the vectors Xₐ and X_{b} are omitted for the mobile robot 4b in FIG. 9.

In the following, the case in which the mobile robot 4a picks the object 1 and object 2 will be used as an example.

The vector Xₐ, which represents the position of the paw of the robot arm portion 41a of the mobile robot 4a, is expressed in a coordinate system with the reference point W as the origin. In contrast, the position vector “xₐ” with respect to the movement portion 42a can be used to represent the position of the paw of the robot arm portion 41a. In this case, “Xₐ=X_{b}+Xₐ” holds true. Collectively, these position vectors are represented by the abstract state vector “z” (or expanded state vector) exemplified in Expression (12).

$$\begin{matrix}[ Expression 12 ] & \\ {z}^{T} = ( {X}_{b} , {X}_{a} , {X}_{1} , {X}_{2} , … ) & ( 12 )\end{matrix}$$

The superscript “T” represents the transpose of a matrix or vector.

The abstract state vector here is a vector whose elements are information representing abstract states. When the vector z is represented as an expanded state vector, information representing the abstract state is included in the elements, and in addition, information about the movement portion 42, information about the robot arm portion 41 such as the position of the robot arm portion 41's paw, and information about the object, or some thereof, may be included in the elements.

The number of variables to be included in the abstract state vector depends on the number of mobile robots 4 used to perform the target task and the number of objects to be considered. When considering one mobile robot 4 and two objects, the abstract model “Σ” can be expressed for the mobile robot 4a, the object 1 and the object 2 of the abstract state setting space 50 shown in FIG. 9, for example, as in Expression (13) below.

$$\begin{matrix}[ Expression 13 ] & \\ {( \begin{matrix}{X}_{a} \\ {X}_{b} \\ {X}_{1} \\ {X}_{2}\end{matrix} )}_{k + 1} = {I ( \begin{matrix}{X}_{a} \\ {X}_{b} \\ {X}_{1} \\ {X}_{2}\end{matrix} )}_{k} + ( \begin{matrix}I & 0 \\ I & I \\ {δ}_{1} I & {δ}_{1} I \\ {δ}_{2} I & {δ}_{2} I\end{matrix} ) ( \begin{matrix}{u}_{b} \\ {u}_{a}\end{matrix} ) & ( 13 )\end{matrix}$$

In Expression (13), k is an integer of k≥1 and represents a time step.

u_{b} denotes the control input for controlling the movement portion 42a of the mobile robot 4a. In the example in Expression (13), u_{b} is a vector that represents the amount of change per time step in the position of the movement portion 42.

uₐ indicates the control input for controlling the robot arm portion 41a of the mobile robot 4a. In the example in FIG. 2, uₐ is a vector that shows the amount of change per time step in the relative position of the robot arm portion 41a's paw relative to the position of the movement portion 42.

I denotes the unit matrix.

δᵢ (i=1, 2) is a logical variable that is “1” when the robot arm portion 41 picks the object i and “0” in other cases. In other words, the logical variable di represents that the object j moves when the robot arm portion has grasped the object j (j=1, 2), but that the object j does not move when not grasped.

The state of whether or not the robot arm portion 41 is grasping the object i, represented by δᵢ, corresponds to an example of discrete dynamics regarding the relationship between the mobile robot 4 and the object i.

Expression (13) represents the time evolution from time step k to k+1, i.e., the dynamics of each abstract state, with each state of the mobile robot 4a, object 1 and object 2 as a state vector.

Expression (13) shows an example of using velocity as the control input, but it is not limited to this case. For example, the control system 100 may use position or acceleration in addition to or instead of velocity as a control input.

In Expression (13), the state of picking is represented by the discrete-valued logical variable δᵢ, and the movement of the object is represented by a continuous value. Thus, Expression (13) indicates a hybrid system. In fact, Expression (13) does not represent the detailed dynamics of the entire mobile robot 4, but only considers the dynamics of the movement of the mobile robot 4 by the movement portion 42 and the paw of the robot arm portion 41 that picks the object. This reduces the number of dimensions of the state vector to be considered in Expression (13), thus reducing the computational complexity of the optimization process.

The fact that the second plan generation portion 12 calculates the target trajectory of the robot arm portion 41 in terms of coordinate values at each time step using Expression (13) is an example of setting a time series of target values based on the constraint condition regarding the mobile robot 4 and the discrete dynamics regarding the relationship between the mobile robot 4 and the object i.

Here, the constraint condition regarding the mobile robot 4 are, for example, the maximum speed of the movement portion 42a and the maximum speed of the paw of the robot arm portion 41a, which are reflected in the values of the vector uₐ and the vector u_{b}.

The hybrid system applied to the abstract model “τ” shown in Expression (13) is not limited to any particular form. For example, the abstract model “Σ” may be configured into a Mixed Logical Dynamical (MLD) system, Hybrid Petri Nets, or Hybrid Automaton.

Next, the second plan generation portion 12 determines the control inputs to the mobile robots 4 for each time step and for each mobile robot 4 based on the target logical expression “Φᵢ”, which includes the concept of time step, and the abstract model “Σ”. In this case, the second plan generation portion 12 solves an optimization problem to minimize the evaluation function for the target task using the abstract model “Σ” and the target logical expression “Φᵢ” including the concept of time step as constraint conditions.

Solving the optimization problem by the second plan generation portion 12 corresponds to the optimization process described above.

The evaluation functions used by the second plan generation portion 12 for the optimization problem are, for example, predetermined for each type of target task and stored in the storage device 3. The evaluation function may be a function that calculates the sum of the distance “dₖ” between the current position of the object and the destination of the object and the control input “uₖ,” and the second plan generation portion 12 may solve an optimization problem that minimizes the evaluation function value. This allows the second plan generation portion 12 to define the time-series control commands so that the energy expended by the mobile robot 4 is minimized.

The larger the evaluation function value in this case, the greater the distance between the object and the destination, or the amount of change in the actuator of the robot arm portion 41 or the movement portion 42 that is being controlled, and so the greater the power consumption. The second plan generation portion 12 can achieve a reduction in power consumption by determining time-series control commands in such a way that the evaluation function value becomes as small as possible. Therefore, the second plan generation portion 12 can achieve a reduction in power consumption by solving an optimization problem that minimizes the evaluation function value.

The distance “dₖ” between the current position of the object and the destination of the object can be calculated as the Euclidean distance at time step k between the object (i=1) and the work table 62, which is the destination, in the case of the target task “the object (i=1) finally exists at the destination, work table 62”. In this case, the sum of the square of the norm of the distance dₖ and the square of the norm of the control input uₖ at the target time step for each sub-task is defined as the evaluation function. The second plan generation portion 12 then solves the constrained mixed integer optimization problem shown in Expression (14) below with the abstract model “2” and the time step target logical expression “φᵢ” as constraint conditions.

$$\begin{matrix}[ Expression 14 ] & \\ {arg min}_{u} ( {\sum }_{k = 0}^{T} ( {‖ {d}_{k} ‖}^{2} + {‖ {u}_{k} ‖}^{2} ) ) s . t . \sum ⋂ {ϕ}_{i} & ( 14 )\end{matrix}$$

In Expression (14), “T” is the number of time steps to be optimized, suitably the target number of time steps for each sub-task defined in the operation sequence output from the first plan generation portion 11.

If the target number of time steps is long, the second plan generation portion 12 may set the number of time steps used for optimization to a value smaller than the target number of time steps. For example, if the target number of time steps is greater than a predetermined threshold, the second plan generation portion 12 may set the number of time steps used for optimization to that threshold.

The second plan generation portion 12 may handle all time steps in a sub-task by dividing them into multiple parts, rather than treating them all together. For example, the second plan generation portion 12 may solve the optimization problem to determine the time-series control command uₖ at each of the times before and after the value of the logical variable representing the abstract representation of the state is switched, such as before and after the robot arm portion 41 grabs the object.

The second plan generation portion 12 may, for example, sequentially determine the control input uₖ by solving the optimization problem each time a predetermined number of time steps elapse.

The second plan generation portion 12 may solve the optimization problem by integer programming as a continuous relaxation problem by approximating the logical variables to continuous values. This allows the second plan generation portion 12 to reduce the computational complexity of solving the optimization problem.

If STL is employed instead of linear temporal logic (LTL) expression as the time-phase logic to be represented in the target logical expression, the second plan generation portion 12 can solve the optimization problem as a nonlinear optimization problem.

The relationship between the output of the first plan generation portion 11 and the output of the second plan generation portion 12 shall be explained here. Specifically, the relationship between multiple sub-tasks and their correspondence to multiple mobile robots 4 shall be described.

As mentioned above, the processing of the second plan generation portion 12 corresponds to the “plan” process in the example operation sequence for the picking task shown in FIG. 8. In the example operation sequence in FIG. 8, the “plan” process is assigned to the mobile robots 4a and 4b at different time steps. This assignment is determined by the first plan generation portion 11 based on the constraint condition information I2 and sub-task information I4, and the like stored in the accumulated information storage portion 31, as described above, considering evaluation indicators such as the number of mobile robots 4, the power consumption, or work time, or a combination thereof.

The optimization problem illustrated in Expression (13), which is performed by the second plan generation portion 12, is generally computationally intensive. When, as in the example in FIG. 8, the second plan generation portion 12 executes optimization problems for multiple sub-tasks such as picking and placing involving multiple mobile robots 4, if multiple optimization problems overlap at the same time step, the computation time may increase or the processing may be interrupted due to the heavy processing load.

When such processing delays or interruptions occur, the control system 100 will not be able to start and complete sub-task operations at the time steps anticipated in the operation sequence. A delay or interruption of processing in one sub-task will affect other subsequent sub-tasks and the operation of other mobile robots.

In contrast, as shown in the example in FIG. 8, the first plan generation portion 11 determines the operating steps so that multiple “plans” do not overlap at the same time step. This allows the second plan generation portion 12 to avoid delays or interruptions in the process as described above.

Thus, the process by the first plan generation portion 11 has the effect of preventing the occurrence of the problems described above as a system for multiple mobile robots 4.

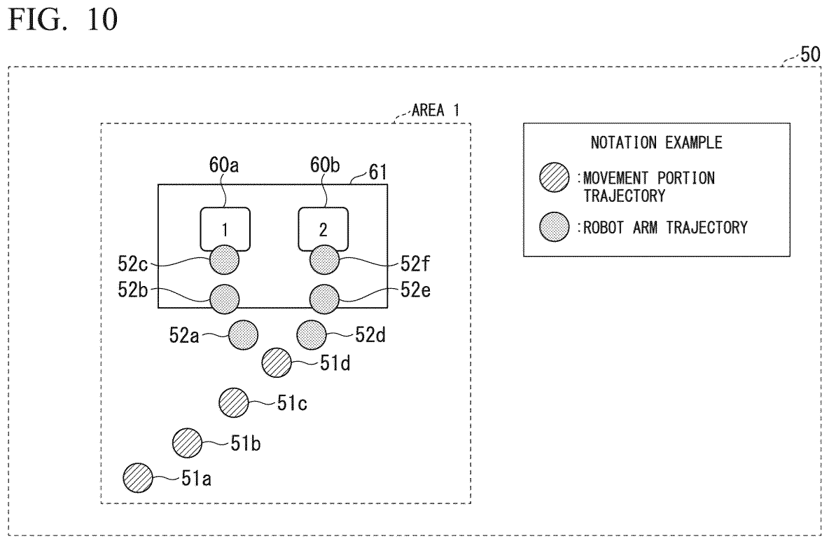

FIG. 10 is a diagram that schematically shows the trajectories of the movement portion of the mobile robot 4 and the paw of the robot arm, as output by the second plan generation portion 12. FIG. 10 shows an example of the pick sub-task performed by the mobile robot 4a shown in FIG. 8.

By determining the abstract state vector z and control input u for each time step based on the optimization process described above, the second plan generation portion 12 can specify a trajectory for the mobile robot 4a as illustrated in FIG. 10.

In the example in FIG. 10, the movement portion 42 moves from one reference position 51a to a point 51d set in the vicinity of the work table 61. That is, the vector “X_{b}” illustrated in FIG. 9 transitions from point 51a to 51d.

Point 51a is an example of a reference point set within area 1. For example, the second plan generation portion 12 sets the point 51a based on the position of the work table 61, the positions of the objects 60a and 60b, the presence or absence of obstacles in the area 1, and the positions of obstacles if any. The second plan generation portion 12 may set a reference point for each area that is set as an area where the mobile robot 4 performs sub-tasks using the robot arm portion 41, such as each of Area 1 and Area 2 in FIG. 9.

However, the method by which the second plan generation portion 12 obtains the location information of the reference point is not limited to the method by which the reference point is calculated each time a time-series control command is generated.

For example, the second plan generation portion 12 may link the location information (e.g., coordinate values) of the calculated reference point with the area identification information and include it in the environmental map information I7 to be stored in the accumulated information storage portion 31. Then, when the second plan generation portion 12 generates a time-series control command for an area for which the reference point has already been calculated, the location information of the reference point in that area may be read from the environmental map information I7.

Alternatively, for one or more areas, a reference point in that area may be preset, for example, by a person, or preset by some other method other than the one calculated by the second plan generation portion 12. In this case, too, the accumulated information storage portion 31 may link the location information of the reference point with the area identification information, include it in the environmental map information I7 and store it in advance. Then, when the second plan generation portion 12 generates a time-series control command for an area for which the reference point has already been calculated, the location information of the reference point in that area may be read from the environmental map information I7.

When the movement portion 42 reaches the position of point 51d, the robot arm portion 41 moves so that the robot arm portion 41's own paw position passes through the trajectory of points 52a to 52c in order to pick the object 1. That is, the vector “Xₐ” illustrated in FIG. 9 transitions from point 52a to 52c.

Then, after picking the object 1, the robot arm portion 41 stores the object 1 in the mobile robot by, for example, following the same trajectory of points 52a to 52c in reverse.

Similarly, the robot arm portion 41 moves so that the robot arm portion 41's own paw position passes through the trajectory of points 52d to 52f in order to pick the object 2. That is, the vector “Xₐ” illustrated in FIG. 9 transitions from point 52d to point 52f.

Then, after picking the object 2, the robot arm portion 41 stores the object 2 in the mobile robot by, for example, following the same trajectory from point 52d to point 52f in reverse.

The trajectories and point spacing shown in FIG. 10 are examples and are not limited to these. These trajectories and intervals can vary depending on the constraint condition information I2, the operation limit information I3, and the results of the optimization shown in Expression (13).

The time steps corresponding to points 51a to 51d of the trajectory of the movement portion 42 and the time steps corresponding to points 52a to 52f of the robot arm portion 41's paw may or may not overlap each other in overlapping periods. The presence or absence of these overlaps can be determined by the evaluation function or constraint conditions in solving the optimization problem in Expression (14). For example, the user may set in advance whether or not these overlaps occur, and the accumulated information storage portion 31 may store the setting information.

Next, the second plan generation portion 12 calculates and outputs time-series control commands (trajectory information) in the form of sub-task sequences that can be received by the mobile robot 4, based on the abstract state vector z and control input u for each time step obtained in the optimization process. The sub-task sequence here is a sequence showing operation commands of a more detailed time-series that further decomposes the sub-tasks including temporal changes among the sub-tasks included in operation sequence generated by the first plan generation portion.

Individual tasks that are further divided into sub-tasks are also referred to as action policies. A sub-task sequence is a sequence of combined operation policies.

For example, for the “place” sub-task, the sub-task sequences that can be received by the mobile robot 4 are defined as a combination of the operation policy “move”, which indicates the self-position of the mobile robot 4, i.e., the movement of the movement portion 42, the operation policy “reach”, which indicates the movement of the paw of the robot arm portion 41 of the mobile robot 4, the operation policy “grasp”, which indicates the grasping motion of picking an object, and the operation policy “reach”, which indicates the placing operation for placing the object at the destination, and stored as sub-task information I4.

In the operation policy “move”, which represents the movement of the self-position, the second plan generation portion 12 outputs the control input u to transition the position vector “X_{b}” of the movement portion 42 from point 51a to 51d, which was obtained in the optimization process. The movement policy “move” is indicated as information that associates the pre-movement position of the movement portion 42 with the endpoint position, for example, by a function that takes the pre-movement position of the movement portion 42 and the endpoint position as arguments. The pre-movement position of the movement portion 42 corresponds to the initial value in the operation policy “move”.

In the operation policy “reach” representing reaching, the second plan generation portion 12 outputs the control input u to transition the position vector “Xₐ” of the paw of the robot arm portion 41 from point 52a to 52c or vice versa, as obtained by the optimization process.

Similarly, the operation policy in which the second plan generation portion 12 outputs the control input u in order to transition the position vector “Xₐ” of the robot arm portion 41's paw from point 52d to 52f, or in the opposite direction, is also “reach”. These operation policies “reach” are characterized, for example, by a starting point and an end point. For example, we can distinguish these operation policies “reach” by representing them as functions with a starting point and an ending point as arguments.

In the operation policy “grasp”, which represents the picking operation for picking an object, the second plan generation portion 12 outputs the control input u to perform the operation of picking an object based on the position and orientation information of the object, with the point 52c or the point 52f in FIG. 10 serving as the starting point.

The second plan generation portion 12 obtains the control input u for each time step by, for example, solving the optimization problem shown in Expression (14). The second plan generation portion 12 then calculates the trajectory in the entire sub-task as illustrated in FIG. 10, based on the obtained control input u and the dynamics shown in Expression (13). The second plan generation portion 12 generates information representing the displacement of positions for each time step as trajectory information.

The second plan generation portion 12 decomposes the calculated displacement of position into the displacement of the position of the mobile robot 4 by the movement portion 42 and the displacement of the position of the robot arm portion 41's paw.

The displacement of the position of the mobile robot 4 and the displacement of the position of the robot arm portion 41's paw can each be expressed as a function.

The control input u may contain information to control an end-effector associated with the robot arm portion 41 of the mobile robot 4. For example, the robot arm portion 41 may be equipped with a vacuum robot hand, and the control input u may contain information to control suction by the robot hand.

In addition to information specifying the position of the mobile robot 4 or a portion thereof, the control input u may also include information specifying the orientation of the mobile robot 4 or a portion thereof.

In the example of FIG. 10, the control input u may include the respective 3-D coordinate values (3-D vector values) of points 52c and 52f as information specifying the position at which the end effector of the robot arm portion 41 picks the object. In addition, the control input u may contain information indicating the orientation of the end-effector when picking the object. In this case, the control input u may contain 6-dimensional coordinate values (6-dimensional vector values) as information indicating the position and orientation of the end-effector when picking the object.

For example, the second plan generation portion 12 may read information indicating the reference posture of the object, such as information on the object's long axis direction and normal direction, from the object model information I6 in the accumulated information storage portion 31. The second plan generation portion 12 may then calculate the position and orientation of the end-effector as it approaches the object and include them in the control input u so that the end-effector can properly pick the object based on the information read out.

In the following, the end effector of the robot arm portion 41 may be equated with the paw of the robot arm portion 41.

The control input u for having the mobile robot 4 execute the operation policy “grasp” may include information indicating whether the robot arm portion 41 picks the object or not.

For example, in FIG. 10, the control input u may include the state of the paw of the robot arm portion 41 of the mobile robot 4 before the execution of the operation policy “grasp” and the state of the picked object before the execution of that sub-task. The state of the paw of the robot arm portion 41 may include the value of the logical variable “δᵢ” in Expression (13), in addition to information indicating the positional orientation of the paw at point 52c or 52f. In other words, each of these can be represented as functions with their respective arguments.

Here, the control input u is obtained as a result of the optimization performed by the second plan generation portion 12. Thus, as in the Move case, the Grasp portion of the trajectory shown in FIG. 10 can be expressed as a function. A function that represents an operation policy Move is also denoted by the function Move. A function representing an operation policy Reach is also denoted as the function Reach. A function representing an operation policy Grasp is also denoted as the function Grasp.

In the case of the example in FIG. 10, the function Move, which takes the starting and ending positions as arguments, moves the robot arm portion 41's paw close to the object, and then switches from the function Move to the function Grasp. The function Grasp can be populated with the current position, the position of the object, and logical variables as arguments to generate a transition to grab the object.

As described above, the value “1” of the logical variable “δᵢ” represents the state in which the robot arm portion 41 is picking the object i, and the value “0” represents the state in which the robot arm portion 41 is not picking the object i. Therefore, a change in the value of the logical variable “δᵢ” from “0” to “1” indicates that the robot arm portion 41 picks the object i. A change in the value of the logical variable “δᵢ” from “1” to “0” indicates that the robot arm portion 41 places the object i.

Thus, the function “Grasp” can represent both picking and placing actions. The function Grasp can be switched and used for both picking and placing.

From the above, the second plan generation portion 12 can set up a sub-task sequence or function from the results of the optimization process as follows.

The second plan generation portion 12 sets the function “Move” based on the state transition of the movement portion 42 of the mobile robot 4. The second plan generation portion 12 sets the function “Reach” based on the state transition of the paw of the robot arm portion 41 of the mobile robot 4. The second plan generation portion 12 sets the function “Grasp” based on the state transitions of the paw of the robot arm portion 41 and the transition of the value of the logical variable di at each time step. An example of the resulting sub-task sequence is shown in FIG. 11.

FIG. 11 shows an example of an operation policy that further divides some of the sub-tasks included in the operation sequence when two mobile robots 4 work together to transport an object. FIG. 11 shows an example of when the second plan generation portion 12 further divides each of the “place” and “pick” sub-tasks of the operation sequence shown in FIG. 8 into operation policies.

Of the sub-tasks obtained as the output of the first plan generation portion 11, the “pick” and “place” sub-tasks, which are subject to trajectory generation by the second plan generation portion 12, are represented by the functions “Move,” “Reach” and “Grasp” through the second plan generation portion 12. In the example in FIG. 11, the function “Move” is indicated by “M”, the function “Reach” by “R”, and the function “Grasp” by “G”.

The function “Move” is a function that represents the movement of the movement portion 42. The function “Reach” is a function that represents the movement of the robot arm portion 41 to cause the paw to reach the target object. The function “Grasp” is a function that represents the action of the robot arm portion 41 picking the object.

However, the functions used by the second plan generation portion 12 are not limited thereto.

In the example in FIG. 11, the “pick” sub-task shows the “pick one object” operation. The “place” sub-task indicates the operation of “placing one object.”

For example, in the case of the “pick” sub-task, the function “Move” causes the movement portion 42 to move. Next, in the first function “Reach”, the robot arm portion 41 moves so that the paw reaches the position of the object. Then, with the function “Grasp”, the robot arm portion 41 picks the object. Then, in the second function “Reach”, the robot arm portion 41 moves the position of the paw back from the object position to the initial position.

### (Control Portion)

The operation of the control portion 14 shall be described in relation to the sub-task sequence. An operation sequence generated by the first plan generation portion 11 or a time series of control inputs u generated by the second plan generation portion 12 is input to the control portion 14.

The control portion 14 controls each mobile robot 4 on the basis of these inputs. Specifically, the control portion 14 controls each mobile robot 4 to operate according to a sub-task for each time step shown in the operation sequence, or an operation policy that further subdivides the sub-tasks.

For example, in the process shown in FIG. 11, the control portion 14 supplies control signals generated based on the function “Move” to the controller of the mobile robot 4 to control the self-position of the movement portion 42 to follow the movement sequence. The control portion 14 supplies control signals generated based on the function “Reach” to the controller of the mobile robot 4 to control the paw of the robot arm portion 41 so as to follow the operation sequence. The control portion 14 supplies control signals generated based on the function “Grasp” to the controller of the mobile robot 4 and performs control so that the paw of the robot arm portion 41 and the end-effector connected to the robot arm portion 41 follow the operation sequence.

In the above, it is assumed that the control portion 14 supplies control signals to the (not shown) controller of the mobile robot 4 and controls it via that controller, but this is not the case. For example, the movement portion of the mobile robot 4 may have a function equivalent to an independent control portion and directly supply control signals. The same is true for end effectors.

The control portion 14 terminates control when the sub-task sequence is completed, i.e., when there are no more control commands. In this case, the recognition processing portion 13 may recognize the state of the object based on information from the environmental information input portion 22 or other sensors, for example. The first plan generation portion 11 may then determine whether the target task has been completed based on the recognition results of the object's state.

For example, if the target task is a picking task, after the target task is completed, the object to be picked by the robot arm portion 41 is not recognized, i.e., it is gone. This allows the control portion 14 to determine when to end control. On the other hand, if the recognition processing portion 13 recognizes that the object to be picked by the robot arm portion 41 is still at its original position, it can determine that the target task has not been completed. In this case, the control system 100 may re-execute the target task by executing the operational flow of the present example embodiment shown in FIG. 4 again.

The effect of the control portion 14 being centralized in the planning device 1 instead of the mobile robot 4 in the control system 100 is described below. The control of each mobile robot 4 depends on the characteristics of the housing and the moving parts of each mobile robot 4. In other words, each mobile robot 4 has individual differences in weight, inertia, and resistance, and the control parameters differ according to these individual differences. It is preferable that the control parameters be set appropriately for each mobile robot 4 according to individual differences.

In a configuration where a large number of mobile robots 4 each have their own control portion, it is necessary to set control parameters individually based on the information of each mobile robot 4.

On the other hand, in the present example embodiment, the control portion 14 corresponding to the individual differences of the mobile robot 4 is arranged in the planning device 1. Therefore, in the control system 100, operations such as setting and management of individual mobile robots 4 can be performed centrally by the planning device 1, and in this respect, setting and management are easy. Information on the characteristics or parameters of each mobile robot 4 may be stored in the accumulated information storage portion 31.

The present invention provides a method for efficiently executing a target task using multiple mobile robots. A specific example of efficiency improvement here is the reduction of work time (also called cycle time) or power consumption to complete the target task.

On the other hand, the operation of multiple mobile robots involves two major aspects: hardware (HW) and software (SW). Hardware challenges can be viewed as challenges in terms of system configuration or architecture. The software aspect of the challenge can be viewed as the algorithmic aspect of the challenge.

In terms of hardware, for example, increasing the computation processing for each mobile robot 4 requires that each mobile robot 4 be equipped with a computer that consumes high power, which reduces the drive (operation) time.

A possible solution to this issue is to offload the computation process to an external server using communication. In this case, especially when a target task consisting of multiple sub-tasks is executed by multiple mobile robots, it is necessary to assign calculation processing to the server side at the appropriate timing based on the task content, the current position and orientation and other conditions of each mobile robot, and the surrounding environment.

If the calculation processes for multiple time steps overlap at the same time step, the processing load may increase and the calculation time may increase or the process may be interrupted. As a result, it will not be possible to start and complete the sub-task operation at the time step originally planned. A delay or interruption in the processing of one sub-task can affect other subsequent sub-tasks and the operation of other mobile robots 4.

This can cause delays to accumulate and can also cause even greater problems, such as stopping all mobile robots 4 during recovery.

Regarding the communication of the mobile robot 4, it is preferable to use wireless communication from the viewpoint of avoiding limiting the range of mobility. On the other hand, when the mobile robot 4 communicates wirelessly, uncertainties in the wireless environment can occur, such as the shielding of wireless signals as the mobile robot 4 moves. There may be cases where the process cannot be offloaded from the mobile robot 4 to the external server at the ideal timing due to radio interference or other reasons.

On the software side, it is necessary to set and adjust (tune) software parameters for each of the mobile robots 4, each type of task, and each environmental condition, in order to respond to a variety of situations. The burden of performing these settings and adjustments is expected to increase in proportion to the number of mobile robots, the complexity of the target task, the frequency of changes in the operating environment of the mobile robot 4, and the magnitude of those changes.

Moreover, configuring and adjusting software parameter values and other parameters generally requires expertise, and the human man-hours involved can become a challenge.

Furthermore, even if such settings and adjustments are made, it may be difficult to restore the control system 100 in the event of a situation different from the previously assumed situation, such as a malfunction of the wireless communication of the mobile robot 4, an unexpected change in the operating environment of the mobile robot 4, or a malfunction of the mobile robot 4.

To address such challenges, the present invention has effects on both hardware and software fronts.

In terms of hardware, as shown in the example in FIG. 1, the planning device 1 is configured as a separate device from the multiple mobile robots 4, and the planning device 1 adopts a configuration (architecture) to control the multiple mobile robots 4 in a centralized manner. The planning device 1 and each of the multiple mobile robots 4 are connected via wired or wireless communication.

On the software side, the first plan generation portion 11 and the second plan generation portion 12 can generate the control commands necessary to control the mobile robots 4 in a hierarchical manner, as shown in the examples in FIG. 8 and FIG. 11.

First, as illustrated in FIG. 8, the first plan generation portion 11 roughly plans the timing of processing by each mobile robot 4 in sub-task units. In other words, the first plan generation portion 11 plans the timing of sub-task execution at a higher level of hierarchy.

Next, as illustrated in FIG. 11, the second plan generation portion 12 plans the detailed movements of the mobile robot 4 in each sub-task and generates time-series control commands. In other words, the second plan generation portion 12 plans the timing of the process by the mobile robot 4 at lower levels of the hierarchy.

Thus, the first plan generation portion 11 and the second plan generation portion 12 plan operations of the mobile robot 4 at different levels of processing, space (abstract state space), and time (time step). This allows, among other things, the first plan generation portion 11 to generate plans by abstracting the operations of the mobile robot 4. The first plan generation portion 11 is preferable to perform settings and adjustments of software parameter values, etc., for each of the mobile robots 4 according to individual differences, thereby potentially resolving the challenge of increased workload in configuration and adjustment.

Furthermore, in order to reduce the number of settings and adjustments by experts depending on the situation, the second plan generation portion 12 performs the optimization process by constraining the target logical expressions, especially the conditions considering temporal sequencing, as in the example of Expression (14). This allows the second plan generation portion 12 to generate time-series control commands that automatically satisfy the conditions mathematically, in other words, by computational processing without human intervention.

Thus, according to the control system 100, the combination of a physical architecture that enables assignment of processing to the mobile robots 4 and sharing of computing resources for controlling the mobile robots 4, a function that enables hierarchical planning of processing by the mobile robots 4, and optimization under the target logical expression that takes into account time constraints, produces the effects described above that are not found in conventional methods.

As described above, the first plan generation portion 11 determines, in accordance with a target task that is a process to be executed by the mobile robots 4, an operation sequence for each of the mobile robots 4, the operation sequence being a time series of predetermined sub-tasks serving as operations that can be executed by the mobile robot 4 or the planning device 1. With regard to a sub-task that requires the setting of a time series of control target values with respect to the mobile robot 4, among the sub-tasks included in the operation sequence, the second plan generation portion 12 sets a time series of the target values for causing the mobile robot 4 to execute the sub-task.

According to the control system 100, by executing the operation plan of the mobile robots 4 in two stages, namely, generation of the operation sequence by the first plan generation portion 11 and setting of the time series of target values by the second plan generation portion 12, when processing is performed using multiple mobile robots 4, it is possible to avoid the concentration of the processing load for control of multiple mobile robots 4 at a specific time.

The first plan generation portion 11 obtains a logical expression reflecting the target number of time steps for the execution of the target task, which indicates the state in which the target task has been accomplished and the constraints on the execution of the target task, and generates an operation sequence that satisfies the logical expression.

According to the control system 100, the mobile robot 4 can be controlled to perform the target task reflecting constraint conditions arising from obstacles and other factors and within the target time step, and in this respect, the mobile robot 4 can be controlled with high precision.

The first plan generation portion 11 generates logical expressions representing the state for each time step using logical expressions in temporal logic.

This allows the first plan generation portion 11 to handle the concept of time using temporal logic, making it relatively easy to indicate the state of each time step. It is also expected that the first plan generation portion 11 will be able to generate logical expressions in a form that is relatively easy for people to understand by using temporal logic to express logical expressions.

For sub-tasks included in the operation sequences generated by the first plan generation portion 11 that require the setting of a time series of target values of control for each of the mobile robots 4, the second plan generation portion 12 sets the time series of target values based on the constraint condition relating to the mobile robot 4 and the discrete dynamics regarding the relationship between the mobile robot 4 and the object in the target task.

According to the control system 100, the state of, for example, whether the robot arm portion 41 is picking an object or not, can be represented by logical variables. According to the control system 100, it is relatively easy to obtain plans that reflect discrete states in this regard.

The second plan generation portion 12 determines a plan that includes moving the mobile robot 4 to the set reference point, moving the robot arm portion 41 of the mobile robot 4 to the position for executing the operation related to the sub-task after the mobile robot 4 has moved to the reference point, and having the robot arm portion 41 execute the operation related to the sub-task after the robot arm portion 41 has moved to the position for executing the operation related to the sub-task.

By moving the mobile robot 4 to the reference point, it is possible to position the robot arm portion 41 in a state where it can reach the object. According to the control system 100, in this regard, it is relatively easy to determine a plan for executing sub-tasks that use the robot arm portion 41 to handle the object.

The second plan generation portion 12 also sets a reference point for each designated area.

According to the control system 100, when there are multiple sub-tasks to handle an object using the robot arm portion 41, it is relatively easy to determine a plan to execute these sub-tasks.

For each type of object to be transported in the target task and for each destination, the input device 2 receives the input of the number on an input screen that receives the input of the number of objects to be transported to the destination.

This allows the user to specify the target task with a simple on-screen manipulation.

The input device 2 receives the selection of one of the following methods for specifying the number of mobile robots 4 to be used to execute the target task: specifying the number as a fixed value, specifying the number based on power consumption, or specifying the number based on work time.

This allows the user to direct the policy for determining the number of mobile robots 4 by the simple method of selecting the desired operation method. If one wishes to specifically specify the number of mobile robots 4, one can select to enter the number of pieces.

### First Modification

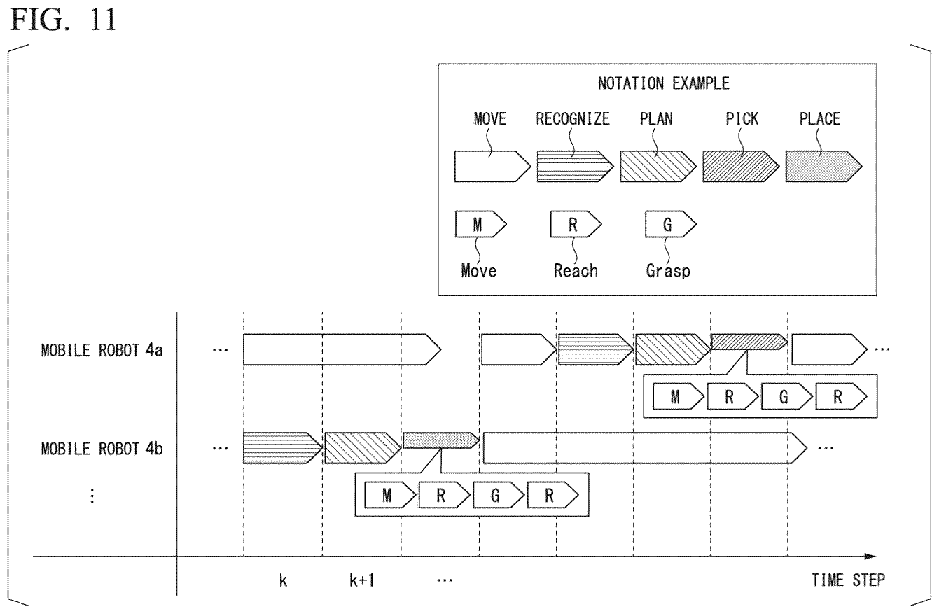

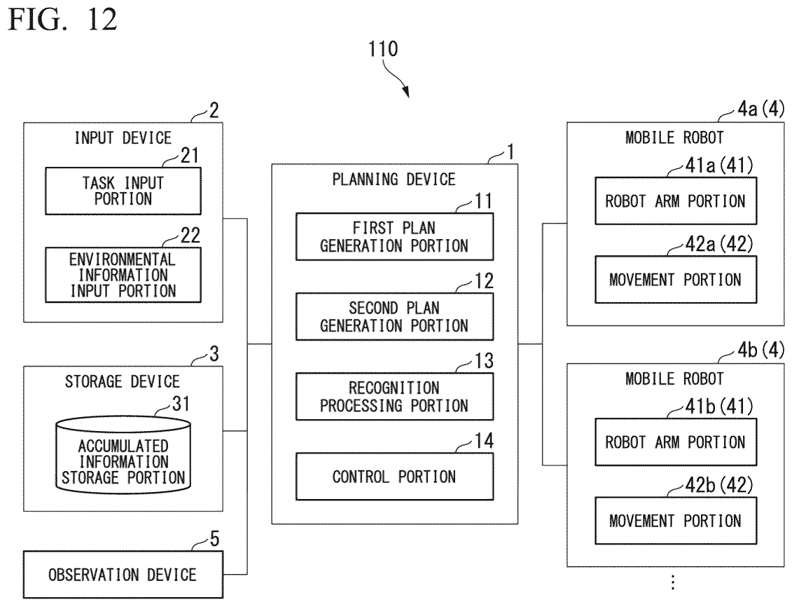

FIG. 12 is a diagram showing a first modification of the control system according to the first example embodiment. A control system 110 shown in FIG. 12 corresponds to a modification of the control system 100 of the first example embodiment. In the control system 110, in addition to the configuration of the control system 100 in FIG. 2, the observation device 5 is connected to the planning device 1.

The observation device 5 may be an observation device comprising one or more sensors, which may be a camera (2-D or 3-D camera), a range finder (e.g., LiDAR or Radar), sonar, or a combination thereof. One observation device 5 may output the results of observations covering the workspace in which the mobile robot 4 performs the target task. Alternatively, multiple observation devices 5 may be set up at different locations in the workspace.

In the case of the example in FIG. 9, the observation device 5 should be installed so that the work table 61 and the work table 62 are at least within the observation area.

The observation device 5 outputs as observation results, for example, any one or a combination of RGB images, 3D depth data, or point cloud data for each of the objects 60a and 60b shown in FIG. 9.

The 3D depth data is data to which data indicating the distance between the sensor and the object to be measured is added for each cell, such as for each pixel of 2D image data.

The observation results from the observation device 5 are used to set the abstract state described above for the planning device 1. For example, the observation device 5 obtains and outputs environmental information similar to the environmental information input portion 22 as a result of the observation. In this case, the control system 110 can use the data obtained by the observation device 5 instead of the data obtained by the environmental information input portion 22. Therefore, the input device 2 does not have to be equipped with an environmental information input portion 22.

The observation device 5 is an example of an environmental information input means.

If both the environmental information input portion 22 and the observation device 5 are provided in the control system 110, the planning device 1 may selectively use either the information from the environmental information input portion 22 or the information from the observation device 5. Alternatively, the planning device 1 may integrate and use information from both the environmental information input portion 22 and the observation device 5.

Other than the above, the control system 110 is similar to control system 100.

### Second Modification

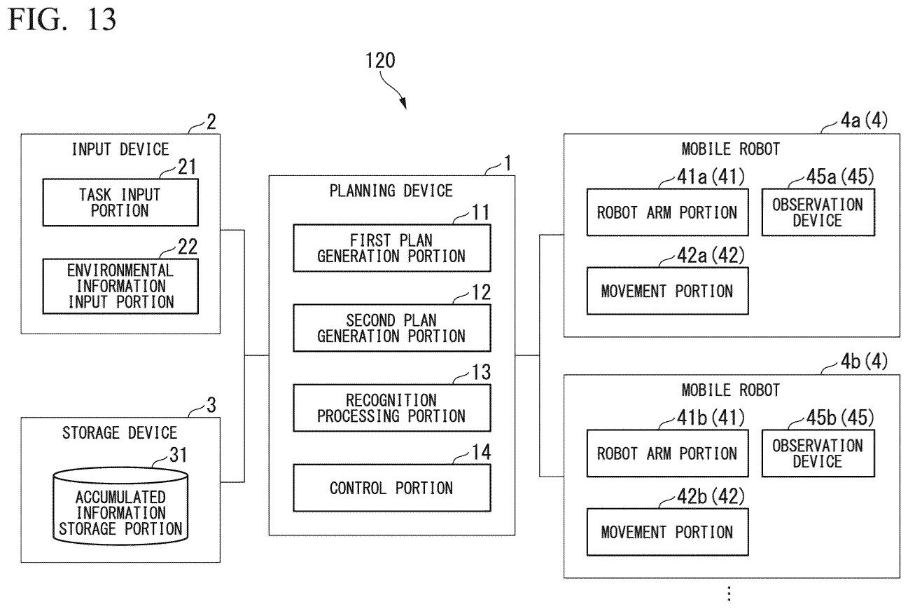

FIG. 13 is a diagram showing a second modification of the control system according to the first example embodiment. A control system 120 shown in FIG. 13 corresponds to a modification of the control system 100 of the first example embodiment. In the control system 120, in addition to the configuration of the control system 100 in FIG. 2, the mobile robots 4a, 4b, . . . have observation devices 45a, 45b, . . . .

The observation devices 45a, 45b, . . . are also collectively referred to as observation devices 45.

FIG. 13 shows an example where the observation devices 45 are mounted on all the mobile robots 4. In other words, FIG. 13 illustrates an example in which the mobile robot 4a is equipped with the observation device 45a, the mobile robot 4b is equipped with the observation device 45b, . . . and so on, demonstrating the case where each mobile robot 4 and observation device 45 correspond one to one.

However, the correspondence between the mobile robot 4 and the observation device 45 is not limited thereto. For example, the control system 120 may include a mobile robot 4 that does not have the observation device 45. For the mobile robots 4 that do not have an observation device 45, the planning device 1 may use the information obtained from the environmental information input portion 22, as in the first example embodiment.

The control system 120 may include the mobile robot 4 having multiple observation devices 45. For the mobile robot 4 with multiple observation devices 45, the planning device 1 may selectively use the information output from each observation device 45. For example, the recognition processing portion 13 of the planning device 1 may perform the “recognize” sub-task (recognition process) for each of the multiple observation devices 45. The planning device 1 (e.g., control portion 14) may then evaluate the recognition results of each of the observation devices 45, select one of the recognition results, and use it to control the mobile robot 4.

Alternatively, for the mobile robot 4 with multiple observation devices 45, the planning device 1 may integrate and use the information output from each of the observation devices 45.

The mounting location of the observation device 45 on the mobile robot 4 is not limited to a specific location.

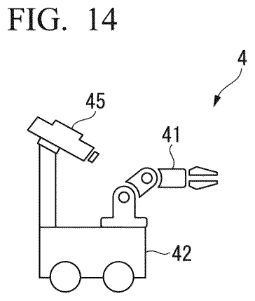

FIG. 14 is a diagram that shows an example of where the observation device 45 is mounted on the mobile robot 4. In FIG. 14, the observation device 45 is mounted on the movement portion 42.

Thus, the observation device 45 may be mounted on the movement portion 42. Alternatively, the observation device 45 may be mounted on the robot arm portion 41.

Similar to the observation device 5 in the first modification described above, the observation device 45 outputs observation results with the workspace where the target task is executed serving as the range. The observation result of the observation device 45 corresponds to an example of environmental information. The observation device 45 is an example of an observation means.

If the combination of all observation devices 45 included in the control system 110 provides information equivalent to that obtained by the environmental information input portion 22, the input device 2 does not need to have the environmental information input portion 22.

Other than the above, the control system 120 is similar to control system 100.

The first modification may be implemented in combination with the second modification. For example, the control system 120 may be equipped with the observation device 5 in addition to or instead of the environmental information input portion 22. In this case, for the mobile robot 4 that is not equipped with the observation device 45, the planning device 1 may use the information obtained from the observation device 5 in addition to or instead of the information obtained from the environmental information input portion 22.

As described above, the input device 2 acquires environmental information, which is information indicating the situation of the work space, being the space in which the mobile robot 4 performs the target task, and provides it to the planning device 1. The observation device 45 acquires environmental information separately from the input device 2.

According to the control system 120, it is expected that more environmental information can be obtained and the mobile robot 4 can be controlled more precisely.

According to the control system 120, the planning device 1 can choose whether to use environmental information from the input device 2 or environmental information from the mobile robot 4 based on the position and remaining battery capacity of the mobile robot 4 and the status of communication between the planning device 1 and the mobile robot 4. According to the control system 200, it is expected that more appropriate environmental information can be obtained by controlling the mobile robot 4 in this regard and that the mobile robot 4 can be operated efficiently.

### Third Modification

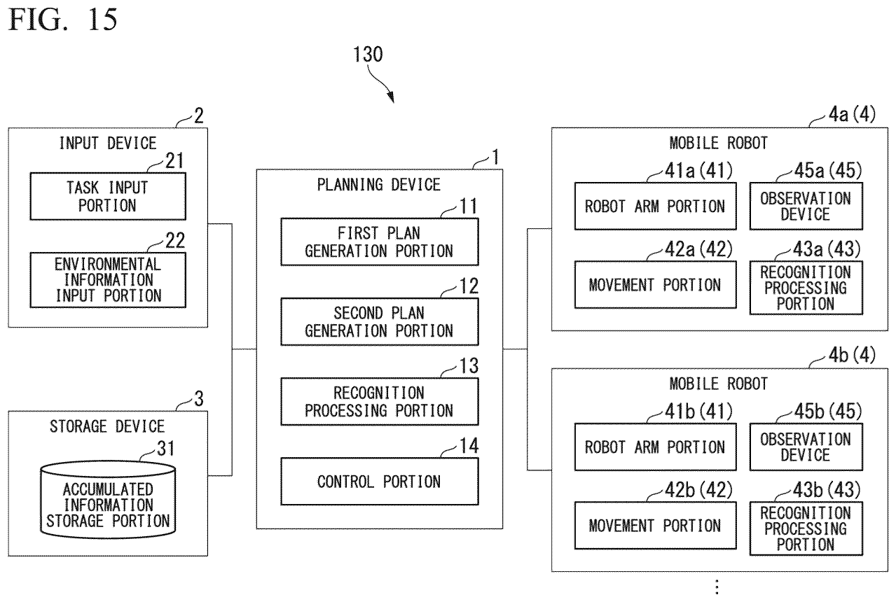

FIG. 15 is a diagram showing a third modification of the control system according to the first example embodiment. A control system 130 shown in FIG. 15 corresponds to a modification of the control system 100 of the first example embodiment. In the control system 130, in addition to the configuration of the control system 100 in FIG. 2, the mobile robots 4a, 4b, . . . have observation devices 45a, 45b, . . . and recognition processing portions 43a, 43b, . . . .

As in the second modification, the observation devices 45a, 45b, . . . are also collectively denoted as observation devices 45. The recognition processing portions 43a, 43b, . . . are also collectively referred to as recognition processing portions 43. As in the case of the recognition processing portion 13, the process performed by the recognition processing portion 43 is also referred to as recognition processing.

FIG. 15 shows an example where the observation device 45 and recognition processing portion 43 are mounted on all the mobile robots 4. In other words, FIG. 15, illustrates an example in which the mobile robot 4a is equipped with the observation device 45a and the recognition processing portion 43a, the mobile robot 4b is equipped with the observation device 45b and the recognition processing portion 43b, . . . and so on, demonstrating the case where the mobile robot 4 and the observation device 45 correspond one to one, and the mobile robot 4 and the recognition processing portion 43 correspond one to one.

However, the correspondence between the mobile robot 4 and the observation device 45 is not limited thereto. For example, the control system 130 may include the mobile robot 4 that does not have either the observation device 45 or the recognition processing device 43, or both. For the mobile robots 4 that do not have an observation device 45, the planning device 1 may use the information obtained from the environmental information input portion 22, as in the first example embodiment. For mobile robots 4 that do not have the recognition processing portion 43, as in the first example embodiment, the recognition processing portion 13 may perform the process of obtaining the information necessary to execute each sub-task from the environmental information.

The observation device 45 is the same as in the second modification and so shall not be described in detail here.

The recognition processing portion 43 obtains the information necessary to execute each sub-task from either the environmental information obtained from the environmental information input portion 22 or the information obtained from the observation device 45. The recognition processing portion 43 is an example of a recognition processing means.

For example, when the mobile robot 4 performs the picking sub-task, the recognition processing portion 43 acquires information such as the type of object to be picked, the number of objects, and the position and orientation of each object. When the mobile robot 4 performs the sub-task of placing, the recognition processing portion 43 obtains information such as the location of the place where the object is to be placed, the spatial extent of the place where the object is to be placed, and the direction from the position of the mobile robot 4 to the location where the object is to be placed.

The recognition processing portion 43 may have the same functions as the recognition processing portion 13. In this case, instead of the recognition processing portion 13 of the planning device 1, the recognition processing portion 43 of the mobile robot 4 can perform the same processing as the recognition processing portion 13.

The first plan generation portion 11 may decide which of the recognition processing portion 13 or the recognition processing portion 43 will perform the processing. For example, when generating the operation sequence illustrated in FIG. 8, the first plan generation portion 11 may determine which of the “recognition” sub-tasks will be performed by the recognition processing portion 13 or the recognition processing portion 43, and record this determination in the operation sequence.

The first plan generation portion 11 may select which of the recognition processing portion 13 or the recognition processing portion 43 will perform the processing based on the information in the accumulated information storage portion 31 and the current (that is, before the “recognition” sub-task is executed) state of each mobile robot 4. For example, if the communication bandwidth and delay between the mobile robot 4 and the planning device 1 are set as the constraint condition information I2, the first plan generation portion 11 can perform the aforementioned selection on the basis of those values.

Furthermore, for example, if the communication bandwidth between the mobile robot 4 and the planning device 1 is narrow or the amount of delay is high, the mobile robot 4 does not transmit the data of the observation result of the observation device 45 to the planning device 1, but instead outputs it to the recognition processing portion 43. The mobile robot 4 then transmits the data resulting from the processing of the data from the observation device 45 by the recognition processing portion 43 to the planning device 1.

On the other hand, if the communication bandwidth between the mobile robot 4 and the planning device 1 is wide and the amount of delay is small, the recognition processing portion 43 does not perform processing, and the mobile robot 4 transmits the data of the observation result of the observation device 45 to the planning device 1.

However, the above conditions and operations are examples and are not limited thereto.

The effect of selectively executing the processing of the recognition processing portion on either the planning device 1 side or the mobile robot 4 side, as described above, is explained below.

As mentioned above, for example, based on the conditions related to communication between the planning device 1 and the mobile robot 4, it is possible to select which side of the planning device 1 or the mobile robot 4 to execute the process. As another example, it may be possible to select which side to execute the process, the planning device 1 side or the mobile robot 4 side, based on conditions related to the power consumption of the mobile robot or the state of the mobile robot, such as the current remaining battery level.

In the control system 120, the planning device 1 and the plurality of mobile robots 4 are separated in the hardware configuration, and the planning device 1 and each of the plurality of mobile robots 4 communicate with each other, which has the following effects.

In particular, when the planning device 1 and the mobile robots 4 communicate wirelessly, the state of this wireless communication can be in various states, depending on the position of each mobile robot and the environment surrounding the mobile robot 4. Also, the power usage, remaining battery power and the like, which is one state of each mobile robot 4, can be in various states.

Thus, there are various possible states that each of the mobile robots 4 and the combination of wireless communication between the mobile robots 4 and the planning device 1 can take, and so there is uncertainty as to what state they are in. In such a situation, it is neither efficient for all mobile robots 4 to uniformly transmit the same amount of observation result information to the planning device 1, nor for all mobile robots 4 to perform uniform processing in the recognition processing portion 43.

For example, the data size of the observation result information by the observation device 45 is larger than the data size of the information after processing by the recognition processing portion 43. In this regard, if observation result information is sent directly from the mobile robot 4 to the planning device 1 when communication characteristics are poor, communication delays or errors may occur.

On the other hand, if the communication characteristics are good, the mobile robot 4 can send observation result information to the planning device 1 without recognition processing by the recognition processing portion 43, thereby reducing the power consumption of the mobile robot 4 comparatively.

If the CPU (Central Processing Unit) utilization of the mobile robot 4 is high, the CPU may become overloaded and the recognition process may be delayed when the recognition processing portion 43 performs the recognition process. When the remaining storage capacity of the battery of the mobile robot 4 is low, if the recognition processing portion 43 performs recognition processing and consumes more power, the recognition process may stop or the entire mobile robot 4 may stop due to lack of power.

On the other hand, if there is CPU underutilization and remaining battery capacity, it may be more efficient for the recognition processing portion 43 on the mobile robot 4 side to perform recognition processing than for the recognition processing portion 13 on the planning device 1 side.

Thus, depending on the communication environment and the state of the mobile robot 4, which of the recognition processing portion 13 or the recognition processing portion 43 is more efficient to perform the recognition processing can vary.

However, it is not realistic for a person to continuously monitor the communication environment and the status of the mobile robot 4 to sequentially determine for each mobile robot 4 which of the recognition processing portion 13 or the recognition processing portion 43 will perform recognition processing, and to manually set or switch between them.

In contrast, in the control system 130, the first plan generation portion 11 can automatically determine for each mobile robot 4 which of the “recognition” sub-tasks to assign to the recognition processing portion 13 or the recognition processing portion 43. In other words, the control system 130 can adaptively change the assignment of recognition processing to the recognition processing portion 13 or the recognition processing portion 43 for each of the multiple mobile robots 4 in response to changes in the communication environment and the state of the mobile robots 4. The control system 130 allows for efficient operation in this regard.

The first modification may be implemented in combination with the third modification. For example, the control system 130 may be equipped with the observation device 5 in addition to or instead of the environmental information input portion 22. In this case, for the mobile robot 4 that is not equipped with the observation device 45, the planning device 1 may use the information obtained from the observation device 5 in addition to or instead of the information obtained from the environmental information input portion 22.

As described above, the recognition processing portions 13 and 43 each obtain the information necessary to execute the sub-tasks from the environmental information.

According to the control system 130, it is possible to choose whether to acquire environmental information on the planning device 1 side or on the mobile robot 4 side, and whether to acquire the information necessary to execute the sub-tasks. This is expected to allow the control system 130 to perform processing efficiently.

When the mobile robot 4 acquires environmental information, it can send the information to the planning device 1 after reducing the amount of information by performing recognition processing that acquires the information necessary to execute the sub-tasks from the environmental information. According to control system 130, the communication load is smaller in this respect.

### Fourth Modification

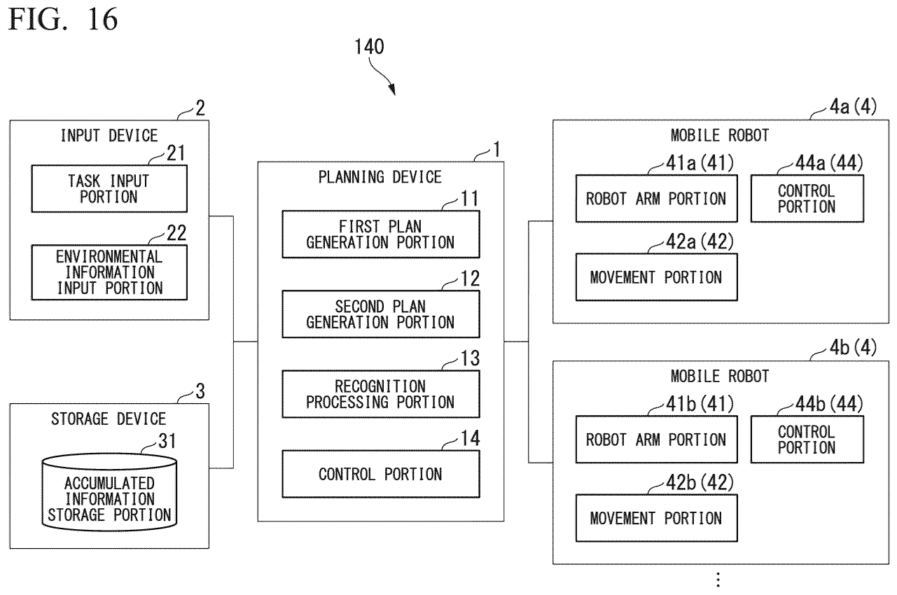

FIG. 16 is a diagram showing a fourth modification of the control system according to the first example embodiment. A control system 140 shown in FIG. 16 corresponds to a modification of the control system 100 of the first example embodiment. In the control system 140, in addition to the configuration of the control system 100 in FIG. 2, the mobile robots 4a, 4b, . . . have control portions 44a, 44b, . . . .

FIG. 16 shows an example where control portion 44 is mounted on all mobile robots 4. In other words, FIG. 16 illustrates an example in which the mobile robot 4a is equipped with the control portion 44a, the mobile robot 4b is equipped with the control portion 44b, . . . and so on, demonstrating the case where each mobile robot 4 and control portion 44 correspond one to one.

However, the correspondence between the mobile robot 4 and the control portion 44 is not limited thereto. For example, the control system 140 may include a mobile robot 4 that does not have the control portion 44. For the mobile robot 4 that does not have the control portion 44, the control portion 14 of the planning device 1 may control the mobile robot 4, as in the first example embodiment.

The control portion 44 receives inputs of time-series control commands output by the planning device 1 and controls each mobile robot 4. In particular, the control portion 44 performs the same operation as the control portion 14 of the planning device 1. Thus, the control portion 44 can be operated instead of the control portion 14.

The control portion 44 is an example of a control means.

The operation of the control portion 44 shall be described here.

The control portion 44, which the mobile robot 4 has, receives from the planning device 1 the operation sequence generated by the first plan generation portion 11, or the time step-by-time step transitions of each state generated by the second plan generation portion 12, or the control input u. The control input u for the operation sequence or time series is illustrated in FIG. 11.

The control portion 44 then controls the mobile robot 4 including itself to follow the time-step-by-time-step transition of each state shown in the operation sequence or time-series control input u. In other words, the control portion 44 performs the same control over the mobile robot 4 including itself as the control portion 14. Alternatively, the control portion 44 can control each part of the mobile robot 4 including the control portion 44 itself in time units finer than a time step, as in the case of the control portion 14.

Thus, instead of the control portion 14 of the planning device 1, the control portion 44 can perform the equivalent process. In such a case, for one mobile robot 4, either the control portion 14 or the control portion 44 should control the mobile robot 4. Which of the control portion 14 or control portion 44 controls the mobile robot 4 can be determined by assignment by the first plan generation portion 11.

In other words, when the first plan generation portion 11 assigns each sub-task as shown in FIG. 8, it selects the “picking” and “placing” sub-tasks corresponding to control from “control by the control portion 14” and “control by the control portion 44 onboard each mobile robot”. The first plan generation portion 11 performs this selection based on the information in the accumulated information storage portion 31 and the current state of the mobile robot. For example, as in the third modification described above, the first plan generation portion 11 may make this selection depending on the state of communication between the planning device 1 and the mobile robot 4, and the state of the mobile robot 4, but is not limited thereto.

The effect of selecting either the processing by the control portion 14, which is on the planning device 1 side, or the processing by control portion 44, which is on the mobile robot 4 side, as described above, shall be explained.

The control portion 14 or the control portion 44 controls the mobile robot 4 so that the state of the mobile robot 4 is in the target state, as described above. Specifically, the current state of each of the moving parts (actuators) provided by the mobile robot 4, such as position, velocity, acceleration, angle of rotation, angular velocity, or angular acceleration, or a combination of these values, is acquired and controlled so that these states become the target states.

The method of control by the control portion 14 or the control portion 44 is not limited to any particular method. For example, the control portion 14 or the control portion 44 may perform feedback control using the position, velocity, acceleration, angle of rotation, angular velocity, or angular acceleration of the movable part of the mobile robot 4, or a combination of these values, but not limited thereto.

When the control portion 14 of the planning device 1 performs feedback control as described above, the delay time between the planning device 1 and each of the mobile robots 4 can affect the control. If the delay time is large, the feedback period of the control becomes longer and the control can become unstable. This delay time depends on, for example, the characteristics of the communication between the planning device 1 and each of the mobile robots 4, the load status of each processing portion such as the control portion 14, and CPU utilization, and can vary from time to time.

If the delay time is long, the control portion 44 onboard the mobile robot 4 can eliminate the effect of the delay by performing control, but the processing by the control portion 44 increases the power consumption and CPU utilization of the mobile robot 4. On the other hand, when the delay time is short, control by the control portion 14 of the planning device 1 can suppress an increase in power consumption and CPU utilization of the mobile robot 4.

However, it is not realistic for a person to continuously monitor this delay time and sequentially determine for each mobile robot 4 which of the control portion 14 or control portion 44 will perform the control, and manually set or switch between them.

In contrast, in the control system 140, makes this possible by adaptive assignment in the first plan generation portion 11.

Adaptive assignment here may be, for example, by the first plan generation portion 11 automatically performing sub-task assignment to the mobile robot 4 when the target task is executed, depending on the execution status of the target task, such as delay time, and the status of the mobile robot 4, such as the remaining battery capacity.

For example, the method of assigning sub-tasks according to the execution status of the target task and the status of the mobile robot 4 may be predetermined in a rule-based format. Further, for example, the first plan generation portion 11 may compare the delay time to a predetermined threshold value and increase the number of mobile robots 4 in operation by one if the execution of the target task is delayed beyond the threshold value.

The first plan generation portion 11 may re-generate the operation sequence according to the execution status of the target task and the status of the mobile robot 4.

Thus, according to the control system 140, efficient operation is possible according to the status of the multiple mobile robots 4.

The first modification may be implemented in combination with the fourth modification. For example, the control system 140 may include the observation device 5 in addition to or instead of the environmental information input portion 22. In this case, for the mobile robot 4 that does not include the observation device 45, the planning device 1 may use the information obtained from the observation device 5 in addition to or instead of the information obtained from the environmental information input portion 22.

The second modification or third modification may be implemented in combination with the fourth modification. For example, one or more of the mobile robots 4 may include either the observation device 45 or the recognition processing portion 43, or both.

Furthermore, the first modification may be combined with the second or third modification and the fourth modification.

As described above, the control portion 14 and 44 controls the mobile robot 4 to perform sub-tasks based on the time series of target values set by the second plan generation portion 12.

According to the control system 140, it is possible to choose whether control of the mobile robot 4 is performed on the planning device 1 side or the mobile robot 4 side, and in this respect, the control system 140 can achieve efficient operation.

For example, if the control of multiple mobile robots 4 is concentrated in the control portion 14 of the planning device 1 and the processing load is high, the control of some of the mobile robots 4 can be transferred to the control portions 44 of the mobile robots 4 to reduce the processing load. When the battery power of the mobile robot 4 is low, the control portion 14 of the planning device 1 can control that mobile robot 4 to reduce the power consumption of the mobile robot 4 and extend its operable time longer.

### Second Example Embodiment

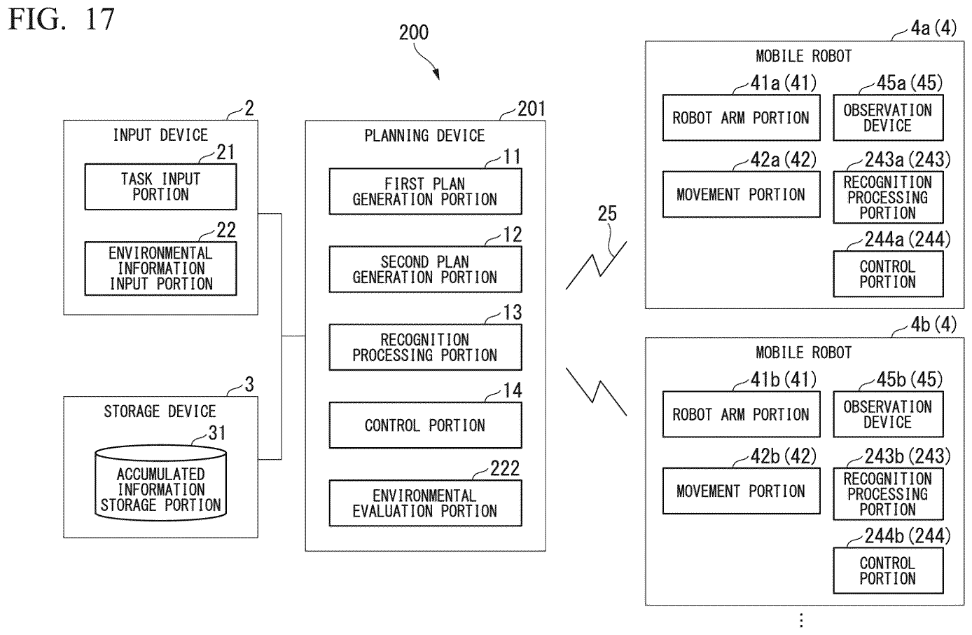

FIG. 17 is a diagram showing an example of the configuration of the control system according to the second example embodiment. In the configuration shown in FIG. 17, a control system 200 includes a planning device 201, the input device 2, the storage device 3, and the mobile robot 4. The planning device 201 includes the first plan generation portion 11, the second plan generation portion 12, the recognition processing portion 13, the control portion 14, and an environmental evaluation portion 222. The input device 2 includes the task input portion 21 and the environmental information input portion 22. The storage device 3 includes the accumulated information storage portion 31. The mobile robot 4 includes the robot arm portion 41, the movement portion 42, the observation device 45, a recognition processing portion 243, and a control portion 244.

When distinguishing the robot arm portion 41 for each mobile robot 4, they are denoted as robot arm portion 41a, 41b, and so on, corresponding to the notation of the mobile robot 4a, 4b, and so forth. When distinguishing the movement portion 42 for each mobile robot 4, they are denoted as movement portion 42a, 42b, and so on, corresponding to the notation of the mobile robot 4a, 4b, and so forth. When distinguishing the observation device 45 for each mobile robot 4, they are denoted as observation device 45a, 45b, and so on, corresponding to the notation of the mobile robot 4a, 4b, and so forth. When distinguishing the recognition processing portion 243 for each mobile robot 4, they are denoted as recognition processing portion 243a, 243b, and so on, corresponding to the notation of the mobile robot 4a, 4b, and so forth. When distinguishing the control portion 244 for each mobile robot 4, they are denoted as control portion 244a, 244b, and so on, corresponding to the notation of the mobile robot 4a, 4b, and so forth.

The control system 200 includes a planning device 201 instead of the planning device 1 of the first example embodiment. The planning device 201 differs from the planning device 1 in that it has the environmental evaluation portion 222 in addition to the portions provided by the planning device 1 in the configuration shown in FIG. 2. Otherwise, the planning device 201 is similar to the planning device 1.

In the control system 200, the mobile robot 4 further includes the observation device 45, the recognition processing portion 243, and the control portion 244 in addition to the configuration of the mobile robot 4 in FIG. 2.

In the control system 200, the planning device 201 and each of the mobile robots 4 are connected by wireless communication 25. The method of wireless communication between the planning device 201 and each of the mobile robots 4 is not limited to any particular method. For example, the planning device 201 and each mobile robot 4 may communicate using local 5G, 5G, 4G, or a local area network or a combination thereof, without being limited thereto.

Other than those points, the control system 200 is similar to the control system 100. Detailed explanations of the points where the control system 200 is similar to the control system 100 shall be omitted here.

The environmental evaluation portion 222 calculates the evaluation value for the wireless communication 25 between the planning device 201 and each mobile robot 4. The environmental evaluation portion may use any of, but not limited to, the throughput of wireless communication, the amount of delay in wireless communication, or the number of mobile robots 4 connected to communication as the evaluation value for wireless communication 25.

The evaluation value calculated by the environmental evaluation portion 222 for wireless communication 25 between the planning device 201 and each of the mobile robots 4 is also referred to as the environment evaluation value. The environmental evaluation portion 222 may calculate an environment evaluation value such that a larger value indicates a higher evaluation and a smaller value indicates a lower evaluation, but is not limited thereto.

The environmental evaluation portion 222 is an example of an environmental evaluation means.

The configuration of the control system 200 according to the second example embodiment is similar to the configuration of the control system 100 when the third and fourth modifications of the first example embodiment are combined. The configuration of control system 200 can be viewed as a configuration in which each mobile robot 4 also has a processing portion corresponding to recognition processing portion 13 and the control portion 14 of the configuration of the control system 100 shown in FIG. 2 and a device corresponding to the observation device 5 of the configuration of the control system 110 shown in FIG. 12.

In the control system 200, all processing after the first and second plan generation portions 11 and 12 generate the operation sequences and time-series control commands illustrated in FIG. 11 can be performed on the mobile robot 4 side. In other words, the control system 200 allows the planning device 201 to complete the target task without the need for communication between the planning device 201 and the mobile robot 4 after the planning device 201 sends the operation sequence and time-series control commands illustrated in FIG. 11 to the mobile robot 4 via wireless communication 25.

Therefore, after the planning device 201 sends the operation sequence and time-series control commands to the mobile robot 4, the mobile robot 4 alone can complete the target task even if the wireless communication 25 between the planning device 201 and the mobile robot 4 becomes unstable or is disconnected.

On the other hand, when the mobile robot 4 executes the processing of the recognition processing portion 243 and the processing of the control portion 244, the operating time by the battery of the mobile robot 4 is reduced due to the power consumption of these processes. In this respect, it is not efficient to always perform the processing of the recognition processing portion 243 and the control portion 244 on the mobile robot 4 side.

Therefore, in the control system 200, the environmental evaluation portion 222 calculates and outputs environmental evaluation values, which are evaluation values related to the wireless communication 25. Based on this environmental evaluation value, the first plan generation portion 11 determines the assignment of sub-tasks to be processed on the planning device 201 side or on the mobile robot 4 side. The first plan generation portion 11 may include the results of the sub-task assignments in the operation sequence.

When the processing of the recognition processing portion 243 is performed on the planning device 201 side, the planning device 201 may obtain information equivalent to the information obtained by the recognition processing portion 243 of the mobile robot 4 from the environmental information input portion 22 of the input device 2.

Alternatively, similar to the configuration of the control system 110, the control system 200 may include an observation device 5 in addition to or instead of the environmental information input portion 22.

When the processing of the control portion 244 is performed on the planning device 201 side, the control portion 14 of the planning device 201 may obtain information equivalent to the information obtained by the control portion 244 of the mobile robot 4.

The environmental evaluation portion 222 may calculate an environmental evaluation value for each mobile robot 4. The first plan generation portion 11 may then determine the assignment of the above sub-tasks for each mobile robot 4.

Alternatively, the environmental evaluation portion 222 may calculate a single environmental evaluation value that is common to all the mobile robots 4. The first plan generation portion 11 may then determine the assignment of the above sub-tasks in common with all the mobile robots 4.

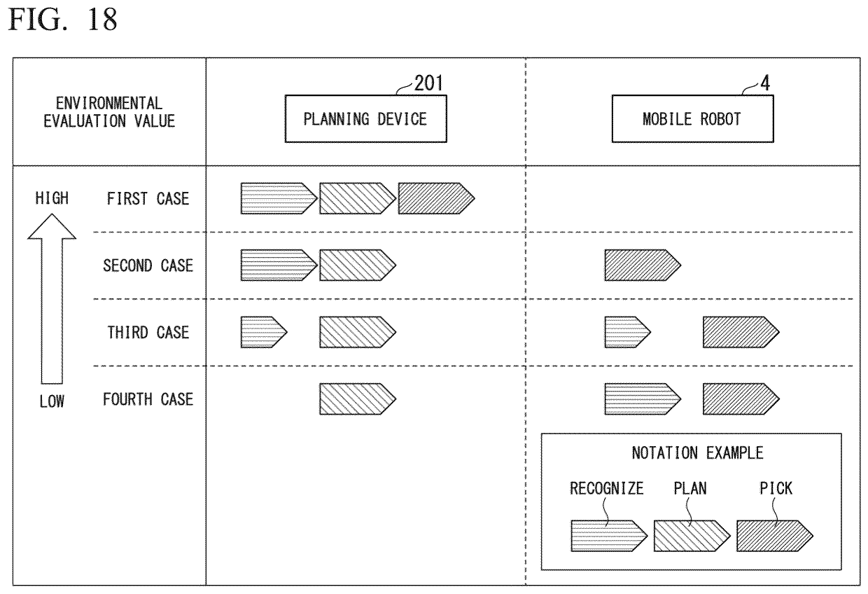

FIG. 18 is a diagram showing an example of the assignment of processing among devices by the first plan generation portion 11 according to the second example embodiment. FIG. 18 shows which of the time-series sub-task outputs, i.e., the “recognize,” “plan,” and “pick” sub-tasks of the operation sequence by the first plan generation portion 11 illustrated in FIG. 8, is performed by the planning device 201 or the mobile robot 4.

In the example in FIG. 18, the sub-tasks illustrated on the planning device 201 side are processed by the recognition processing portion 13 and the control portion 14 in the planning device 201. The sub-tasks illustrated on the mobile robot 4 side are processed by the recognition processing portion 243 and the control portion 244 of the mobile robot 4.

Note that the “plan” sub-task is not subject to assignment of processing here, since it is a sub-task to be executed by the second plan generation portion 12. Here, the horizontal length of the sub-task notation represents the length of processing time required to execute the sub-task. However, the sub-task execution times shown in FIG. 18 are examples and are not limited thereto.

The vertical axis in FIG. 18 shows the height of the evaluation indicated by the environmental evaluation value output by the environmental evaluation portion 222. In the example in FIG. 18, the evaluation indicated by the evaluation environment value is high when the wireless communication conditions are favorable, such as when the wireless communication throughput is high and the delay time is short. On the other hand, the evaluation indicated by the evaluation environment value is low when the wireless communication conditions are poor, such when the wireless communication throughput is low or the delay time long.

In the first case with the highest evaluation indicated by the environmental evaluation value in the example in FIG. 18, all of the “recognize” and “pick” sub-tasks are processed on the planning device 201 side. Specifically, the recognition processing portion 13 performs the “recognize” sub-task, and the control portion 14 performs the “pick” sub-task.

Comparing the second and third cases, which have a slightly lower evaluation indicated by the environmental evaluation values, with the first case, the first plan generation portion 11 partially transfers the execution of the “recognize” and “pick” sub-tasks from the planning device 201 side to the mobile robot 4 side.

In the second case, the recognition processing portion 13 of the planning device 1 performs the “recognize” sub-task, and the control portion 244 of the mobile robot 4 performs the “pick” sub-task.

In the third case, the recognition processing portion 13 of the planning device 1 and the recognition processing portion 243 of the mobile robot 4 share the “recognize” sub-task, while the control portion 244 of the mobile robot 4 performs the “pick” sub-task.

In the third case, the evaluation indicated by the environmental evaluation value is lower than in the second case. Correspondingly, in the third case, it can be said that the first plan generation portion 11 further transfers part of the “recognize” sub-task from the second case to the mobile robot 4 side.

In the fourth case, which has the lowest evaluation indicated by the environment evaluation value, all the “recognize” and “pick” sub-tasks are processed on the mobile robot 4 side. Specifically, the recognition processing portion 243 performs the “recognize” sub-task, while the control portion 244 performs the “pick” sub-task.

Specific reference values for environmental evaluation values, etc., for sub-task assignment may be stored in advance by the accumulated information storage portion 31. For example, the accumulated information storage portion 31 may store a function for calculating the environmental evaluation value, and may also store the threshold value of the environmental evaluation value tied to the sub-task assignment method.

As mentioned above, the first plan generation portion 11 may determine sub-task assignment as illustrated in FIG. 18 for each mobile robot 4. Alternatively, the first plan generation portion 11 may determine one sub-task assignment as illustrated in FIG. 18, common to all the mobile robots 4.

The third case in FIG. 18 shows an example of dividing the processing of the “recognize” sub-task into processing on the planning device 201 side and processing on the mobile robot 4 side.

The processing of these divided sub-tasks is performed, for example, by the mobile robot 4 not transmitting the output of the observation device 45 as is via the wireless communication 25, but rather performing the transmission after the recognition processing portion 243 performs the initial processing. For example, the control system 200 may be configured to perform the following processing.

In general, the data size of RGB image data, 3D depth data, or point cloud data observed by an observation device is large, and furthermore, the data size increases in proportion to the image capture range and resolution of the observation device. Transmitting such a large amount of data when the environmental evaluation value is low, i.e., when wireless communication conditions are poor, leads to a deterioration of processing efficiency due to elongation of the transmission time, and may also result in an error without completing data transmission.

Therefore, the recognition processing portion 243 onboard the mobile robot 4 performs initial processing, for example, extracting only specific regions from the entire region of the captured image (filtering) or reducing the resolution (downsampling). This allows the mobile robot 4 to reduce the size of the data acquired by the observation device 45 before transmitting it via the wireless communication 25.

In the planning device 201, the recognition processing portion 13 performs recognition processing using the size-reduced data and obtains the same processing results as in the case of the recognition processing portion 13 according to the first example embodiment, for example.

However, the method of sharing the processing of one sub-task between the planning device 201 and the mobile robot 4 is not limited thereto.

The recognition processing portion 243 of the mobile robot 4 performs processing equivalent to that performed by the recognition processing portion 13 of the planning device 201. However, the performance of the recognition processing portion 243 (e.g., in terms of specifications) need not be the same as the performance of the recognition processing portion 13. For example, hardware that is lighter in weight and consumes less power may be used as the hardware that performs the functions of the recognition processing portion 243, although it has less processing power than the hardware that performs the functions of the recognition processing portion 13.

The control portion 244 of the mobile robot 4 performs a process equivalent to the process performed by the control portion 14 of the planning device 201. However, the performance of the control portion 244 (e.g., in terms of specifications) need not be the same as the performance of the control portion 14. For example, hardware that is lighter in weight and consumes less power may be used as the hardware that performs the functions of the control portion 244, although it has less processing power than the hardware that performs the functions of the control portion 14.

Thus, by using hardware for the mobile robot 4 that takes gravity and power consumption, or at least either one, into consideration, the power consumption of the mobile robot 4 can be reduced and the operating time can be improved.

As described above, the environmental information input portion 22 acquires environmental information, which is information indicating the situation of the work space, being the space in which the mobile robot 4 performs the target task, and provides it to the planning device 1. Apart from the environmental information input portion 22, the observation device 45 obtains environmental information, which is information indicating the situation of the work space. The recognition processing portions 13 and 243 each obtain the information necessary to execute sub-tasks from the environmental information. The control portions 14 and 244 perform control so that the mobile robot 4 executes the sub-tasks based on the time series of target values set by the second plan generation portion 12. The planning device 1 and each of the mobile robots 4 communicate wirelessly with each other. The environmental evaluation portion 222 outputs evaluation values related to wireless communication. The first plan generation portion 11 determines whether to perform acquisition of environmental information, acquisition of information necessary for executing sub-tasks from the environmental information, and control to have the mobile robot 4 execute the sub-tasks on the mobile robot 4 side or on the planning device 1 side, or both on the planning device 1 side and the mobile robot 4 side.

According to the control system 200, the allocation of processing to be performed on the planning device 1 side and the mobile robot 4 side can be determined according to the situation of wireless communication, and it is expected that the allocation will be made so that processing can be performed efficiently.

In the control system 200, the first plan generation portion 11 determines the assignment of processing of which devices perform sub-tasks. This enables automatic process assignment without the need for manual setting changes or adjustments, even in a configuration where the planning device 201 and multiple mobile robots 4 are communicatively connected via the wireless communication 25 and the state of the wireless communication 25 and the state of the mobile robots 4 change from time to time.

The first plan generation portion 11 performs allocation of processes according to the evaluation value of the state of wireless communication. This allows the control system 200 to adjust the trade-off between processing performance and power consumption of the mobile robot 4 for various states of wireless communication. According to the control system 200, it is possible to ensure the quality of processing for executing the target task in this regard, while at the same time reducing the power consumption of the mobile robot 4 to lengthen its operating time.

### Third Example Embodiment

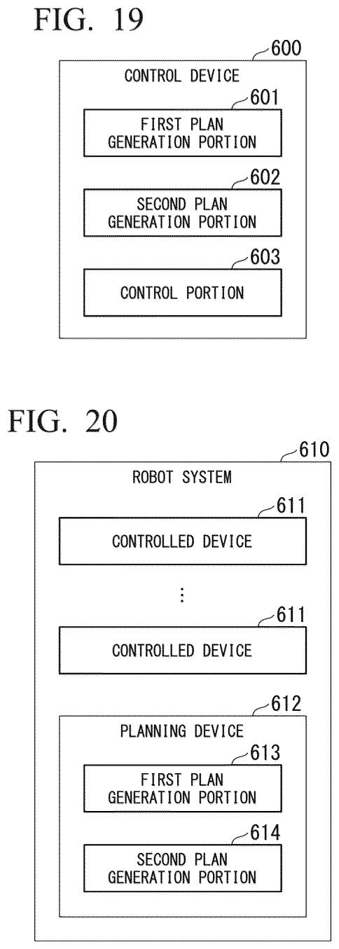

FIG. 19 is a diagram showing an example of the configuration of the control device according to the third example embodiment. In the configuration shown in FIG. 19, a control device 600 has a first plan generation portion 601, a second plan generation portion 602, and a control portion 603.

In such a configuration, the first plan generation portion 601 determines, in accordance with a target task that is a process to be executed by a plurality of controlled devices, an operation sequence for each of the controlled devices, the operation sequence being a time series of predetermined sub-tasks serving as operations that can be executed by the controlled devices or the control device 600.

With regard to a sub-task that requires the setting of a time series of control target values with respect to the controlled devices, among the sub-tasks included in the operation sequence, the second plan generation portion 602 sets a time series of the target values for causing the controlled devices to execute the sub-task.

The control portion 603 controls the control target based on the time series of the operation sequence and target values.

The first plan generation portion 601 is an example of a first plan generation means. The second plan generation portion 602 is an example of a second plan generation means. The control portion 603 is an example of a control means.

According to the control device 600, by executing the operation plan of the controlled device in two stages, namely, generation of the operation sequence by the first plan generation portion 601 and setting of the time series of target values by the second plan generation portion 602, when processing is performed using multiple controlled devices, it is possible to avoid the concentration of the processing load for control of these multiple controlled devices at a specific time.

The functions of the first plan generation portion 601 can be realized using, for example, the functions of the first plan generation portion 11 shown in FIG. 2. The functions of the second plan generation portion 602 can be realized using, for example, the functions of the second plan generation portion 12 shown in FIG. 2. The functions of control portion 603 can be realized using, for example, the functions of control portion 14 and others shown in FIG. 2.

### Fourth Example Embodiment

FIG. 20 is a diagram showing an example of the configuration of the control system according to the fourth example embodiment. In the configuration shown in FIG. 20, a control system 610 includes a plurality of controlled devices 611 and a planning device 612. The planning device 612 includes a first plan generation portion 613 and a second plan generation portion 614.

In such a configuration, the first plan generation portion 613 determines, in accordance with a target task that is a process to be executed by the controlled device 611, an operation sequence for each controlled device 611, the operation sequence being a time series of predetermined sub-tasks serving as operations that can be executed by the controlled devices 611 or the planning device 612.

With regard to a sub-task that requires the setting of a time series of control target values with respect to the controlled devices 611, among the sub-tasks included in the operation sequence, the second plan generation portion 614 sets a time series of the target values for causing the controlled devices 611 to execute the sub-task.

The first plan generation portion 613 is an example of a first plan generation means. The second plan generation portion 614 is an example of a second plan generation means.

According to the control system 610, by executing the operation plan of the controlled device 611 in two stages, namely, generation of the operation sequence by the first plan generation portion 613 and setting of the time series of target values by the second plan generation portion 614, when processing is performed using multiple controlled devices 611, it is possible to avoid the concentration of the processing load for control of these multiple controlled devices 611 at a specific time.

The functions of the controlled devices 611 can be realized using, for example, the functions of the mobile robot 4 shown in FIG. 2. The functions of the planning device 612 can be realized using, for example, the functions of the planning device 1 and others shown in FIG. 2. The functions of the first plan generation portion 613 can be realized using, for example, the functions of the first plan generation portion 11 shown in FIG. 2. The functions of the second plan generation portion 614 can be realized using, for example, the functions of the second plan generation portion 12 shown in FIG. 2.

### Fifth Example Embodiment

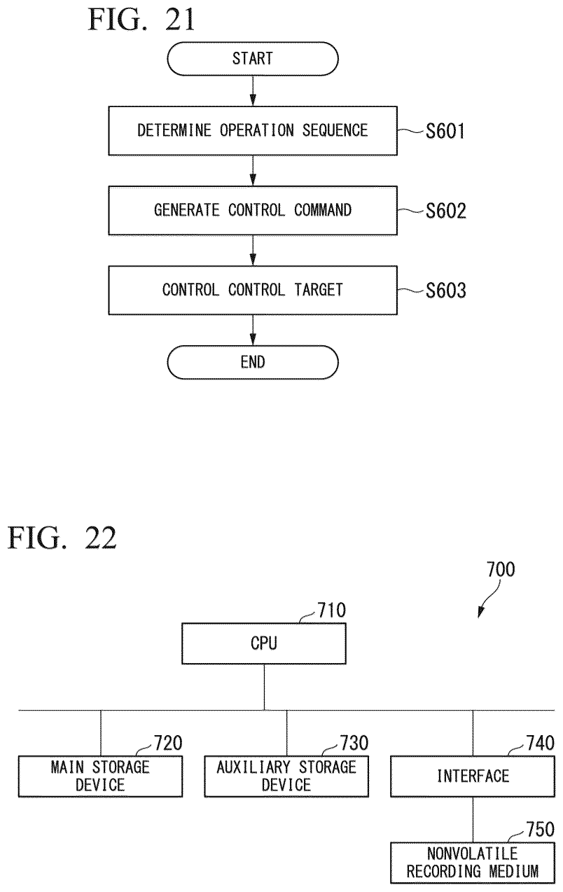

FIG. 21 is a flowchart showing an example of the processing steps in the operation planning method according to the fifth example embodiment. The determination method shown in FIG. 21 includes a control system including a plurality of controlled devices and a planning device, and determining an operation sequence (Step S601) and setting a time series of target values (Step S602).

In determining the operation sequence (Step S601), in accordance with a target task that is a process to be executed by a controlled devices, an operation sequence, an operation sequence is determined for each controlled device, the operation sequence being a time series of predetermined sub-tasks serving as operations that can be executed by the controlled device or the planning device.

In setting the time series of the target values (Step S602), with regard to a sub-task that requires the setting of a time series of control target values with respect to the controlled devices, among the sub-tasks included in the operation sequence, a time series of the target values for causing the controlled devices to execute the sub-task is set.

According to the motion planning method shown in FIG. 21, by executing the operation plan of the controlled device in two stages, namely, generation of the operation sequence and setting of the time series of target values, when processing is performed using multiple controlled devices, it is possible to avoid the concentration of the processing load for control of these multiple controlled devices at a specific time.

FIG. 22 is a schematic block diagram showing the configuration of a computer according to at least one example embodiment.

In the configuration shown in FIG. 22, a computer 700 includes a CPU 710, a main storage device 720, an auxiliary storage device 730, an interface 740, and a nonvolatile recording medium 750.

Any one or more of the above planning device 1, input device 2, mobile robot 4, and planning device 201, or parts thereof, may be implemented in the computer 700. In that case, the processing of each of the above-mentioned processing portions is stored in the auxiliary storage device 730 in program form. The CPU 710 reads the program from the auxiliary storage device 730, deploys it in the main storage device 720, and executes the above processing according to the program. The CPU 710 also secures a storage region in the main storage device 720 corresponding to each of the above-mentioned storage portions according to the program. Communication between each device and other devices is performed by the interface 740, which has a communication function and communicates according to the control of the CPU 710. The interface 740 also has a port for the nonvolatile recording medium 750 and reads information from and writes information to the nonvolatile recording medium 750.

When the planning device 1 is implemented in the computer 700, the processes of the first plan generation portion 11, the second plan generation portion 12, the recognition processing portion 13, and the control portion 14 are stored in the auxiliary storage device 730 in program form. The CPU 710 reads the program from the auxiliary storage device 730, deploys it in the main storage device 720, and executes the above processing according to the program.

The CPU 710 also allocates storage space in the main storage device 720 for processing of the planning device 1 according to the program. Communication between the planning device 1 and other devices is performed by the interface 740, which has a communication function and communicates according to the control of the CPU 710.

Interaction between the planning device 1 and the user is performed by the interface 740, which includes a display device and input device, displays various images and receives user manipulations according to the control of the CPU 710. The interaction between the planning device 1 and the user may take place via the input device 2.

When the input device 2 is implemented in the computer 700, the processing of each part of the task input portion 21 and the environmental information input portion 22 is stored in the auxiliary storage device 730 in program form. The CPU 710 reads the program from the auxiliary storage device 730, deploys it in the main storage device 720, and executes the above processing according to the program.

The CPU 710 also allocates storage space in the main storage device 720 for processing of the input device 2 according to the program. Communication between the planning device 1 and other devices is performed by the interface 740, which has a communication function and communicates according to the control of the CPU 710.

Interaction between the input device 2 and the user is performed by the interface 740, which includes a display device and input device, displays various images and receives user manipulations according to the control of the CPU 710.

When the mobile robot 4 according to the first example embodiment is implemented in the computer 700, the processing of each part of the robot arm portion 41 and the movement portion 42 is stored in the auxiliary storage device 730 in program form. The CPU 710 reads the program from the auxiliary storage device 730, deploys it in the main storage device 720, and executes the above processing according to the program.

The CPU 710 also allocates storage space in the main storage device 720 for processing of the mobile robot 4 according to the program. Communication between the mobile robot 4 and other devices is performed by the interface 740, which has a communication function and communicates according to the control of the CPU 710.

The mobile robot 4 according to the first modification of the first example embodiment is the same as the case of the mobile robot 4 according to the first example embodiment.

When the mobile robot 4 according to the second modification of the first example embodiment is implemented in the computer 700, the processing of each part of the robot arm portion 41, the movement portion 42, and the observation device 45 is stored in the auxiliary storage device 730 in program form. The CPU 710 reads the program from the auxiliary storage device 730, deploys it in the main storage device 720, and executes the above processing according to the program.

The CPU 710 also allocates storage space in the main storage device 720 for processing of the mobile robot 4 according to the program. Communication between the mobile robot 4 and other devices is performed by the interface 740, which has a communication function and communicates according to the control of the CPU 710.

When the mobile robot 4 according to the third modification of the first example embodiment is implemented in the computer 700, the processing of each part of the robot arm portion 41, the movement portion 42, the recognition processing portion 32 and the observation device 45 is stored in the auxiliary storage device 730 in program form. The CPU 710 reads the program from the auxiliary storage device 730, deploys it in the main storage device 720, and executes the above processing according to the program.

The CPU 710 also allocates storage space in the main storage device 720 for processing of the mobile robot 4 according to the program. Communication between the mobile robot 4 and other devices is performed by the interface 740, which has a communication function and communicates according to the control of the CPU 710.

When the mobile robot 4 according to the fourth modification of the first example embodiment is implemented in the computer 700, the processing of each part of the robot arm portion 41, the movement portion 42, and the control portion 44 is stored in the auxiliary storage device 730 in program form. The CPU 710 reads the program from the auxiliary storage device 730, deploys it in the main storage device 720, and executes the above processing according to the program.

The CPU 710 also allocates storage space in the main storage device 720 for processing of the mobile robot 4 according to the program. Communication between the mobile robot 4 and other devices is performed by the interface 740, which has a communication function and communicates according to the control of the CPU 710.

When the mobile robot 4 according to the second example embodiment is implemented in the computer 700, the processing of each part of the robot arm portion 41, the movement portion 42, the observation device 45, the recognition processing portion 243, and the control portion 244 is stored in the auxiliary storage device 730 in program form. The CPU 710 reads the program from the auxiliary storage device 730, deploys it in the main storage device 720, and executes the above processing according to the program.

The CPU 710 also allocates storage space in the main storage device 720 for processing of the mobile robot 4 according to the program. Communication between the mobile robot 4 and other devices is performed by the interface 740, which has a communication function and communicates according to the control of the CPU 710.

When the planning device 201 is implemented in the computer 700, the processes of the first plan generation portion 11, the second plan generation portion 12, the recognition processing portion 13, the control portion 14, and the environmental evaluation portion 222 are stored in the auxiliary storage device 730 in program form. The CPU 710 reads the program from the auxiliary storage device 730, deploys it in the main storage device 720, and executes the above processing according to the program.

The CPU 710 also allocates storage space in the main storage device 720 for processing of the planning device 201 according to the program. Communication between the planning device 1 and other devices is performed by the interface 740, which has a communication function and communicates according to the control of the CPU 710.

Interaction between the planning device 201 and the user is performed by the interface 740, which includes a display device and input device, displays various images and receives user manipulations according to the control of the CPU 710. The interaction between the planning device 201 and the user may take place via the input device 2.

Any one or more of the above programs may be recorded on the nonvolatile recording medium 750. In this case, the interface 740 may read the program from the nonvolatile recording medium 750. The CPU 710 may then directly execute the program read by the interface 740, or it may be stored once in the main storage device 720 or the auxiliary storage device 730 and then executed.

A program for executing all or part of the processes performed by the planning device 1, input device 2, mobile robot 4, and planning device 201 may be recorded on a computer-readable recording medium, and the program recorded on the recording medium may be read by the computer system and executed to perform the processing of each part. The term “computer system” here shall include hardware such as operating systems (OS) and peripheral devices.

In addition, “computer-readable recording medium” means a portable medium such as a flexible disk, magneto-optical disk, ROM (Read Only Memory), CD-ROM (Compact Disc Read Only Memory), or other storage device such as a hard disk built into a computer system. The above program may be used to realize some of the aforementioned functions, and may also be used to realize the aforementioned functions in combination with programs already recorded in the computer system.

The present invention has been described above using the above-described preferred example embodiments as examples. However, the present invention is not limited to the example embodiments described above. The invention can be applied in various forms that do not depart from the gist of the invention.

Some or all of the above example embodiments may also be described as, but not limited to, the following Supplementary Notes.

### Supplementary Note 1

A control device comprising:
a first plan generation means that determines, in accordance with a target task that is a process to be executed by a plurality of controlled devices, an operation sequence for each of the controlled devices, the operation sequence being a time series of predetermined sub-tasks serving as operations capable of being executed by the controlled device or the control device itself;
a second plan generation means that, with regard to a sub-task that requires a setting of a time series of control target values with respect to the controlled device, among the sub-tasks included in the operation sequence, sets a time series of the target values for causing the controlled device to execute the sub-task; and
a control means that controls the controlled devices based on the operation sequence and the target value time-series.

### Supplementary Note 2

The control device according to claim 1, wherein the first plan generation means obtains a logical expression reflecting a target number of time steps for execution of the target task, the logical expression indicating a state in which the target task has been accomplished and a constraint condition in the execution of the target task, and generates the operation sequence that satisfies the logical expression.

### Supplementary Note 3

The control device according to claim 2, wherein the first plan generation means generates the logical expression representing a state of each time step using a logical expression of temporal logic.

### Supplementary Note 4

The control device according to any one of claims 1 to 3, wherein the second plan generation means, with regard to the sub-task that requires the setting of the time series of the control target values with respect to the respective controlled devices, among the sub-tasks included in the operation sequence generated by the first plan generation means, sets the time series of the target values based on a constraint condition relating to the controlled device and discrete dynamics relating to a relationship between the controlled device and an object in the target task.

### Supplementary Note 5

The control device according to any one of claims 1 to 4,
wherein the controlled device is a mobile robot, and
wherein the second plan generation means determines a plan that includes: moving the mobile robot to a set reference point; moving a robot arm of the mobile robot to a position for executing an operation related to the sub-task after the mobile robot has moved to the reference point; and causing the robot arm to execute an operation related to the sub-task after the robot arm has moved to the position for executing the operation related to the sub-task.

### Supplementary Note 6

The control device according to claim 5, wherein the second plan generation means sets the reference point for each designated area.

### Supplementary Note 7

A control system comprising:
a plurality of controlled devices; and
a planning device,
wherein the planning device comprises:
a first plan generation means that determines, in accordance with a target task that is a process to be executed by the controlled devices, an operation sequence for each of the controlled devices, the operation sequence being a time series of predetermined sub-tasks serving as operations capable of being executed by the controlled device or the planning device; and
a second plan generation means that, with regard to a sub-task that requires a setting of a time series of control target values with respect to the controlled device, among the sub-tasks included in the operation sequence, sets a time series of the target values for causing the controlled device to execute the sub-task.

### Supplementary Note 8

The control system according to claim 7,
wherein the first plan generation means obtains a logical expression reflecting a target number of time steps for execution of the target task, the logical expression indicating a state in which the target task has been accomplished and a constraint condition in the execution of the target task, and generates the operation sequence that satisfies the logical expression.

### Supplementary Note 9

The control system according to Supplementary Note 8, wherein the first plan generation means generates the logical expression representing a state of each time step using a logical expression of temporal logic.

### Supplementary Note 10

The control system according to any one of Supplementary Notes 7 to 9,
wherein the second plan generation means, with regard to the sub-task that requires the setting of the time series of the control target values with respect to the respective controlled devices, among the sub-tasks included in the operation sequence generated by the first plan generation means, sets the time series of the target values based on a constraint condition relating to the controlled device and discrete dynamics relating to a relationship between the controlled device and an object in the target task.

### Supplementary Note 11

The control system according to any one of Supplementary Notes 7 to 10,
wherein the controlled device is a mobile robot, and
wherein the second plan generation means determines a plan that includes: moving the mobile robot to a set reference point; moving a robot arm of the mobile robot to a position for executing an operation related to the sub-task after the mobile robot has moved to the reference point; and causing the robot arm to execute an operation related to the sub-task after the robot arm has moved to the position for executing the operation related to the sub-task.

### Supplementary Note 12

The control system according to Supplementary Note 11, wherein the second plan generation means sets the reference point for each designated area.

### Supplementary Note 13

The control system according to any one of Supplementary Notes 7 to 12, further comprising:
an environmental information input means that acquires environmental information that is information indicating a situation of a work space, the work space being a space in which the controlled devices perform the target task, and provides the environmental information to the planning device,
wherein one or more of the controlled devices comprise an observation means that acquires environmental information that is information indicating a situation of the work space, separately from the environmental information input means.

### Supplementary Note 14

The control system according to Supplementary Note 13, wherein both of the planning device and each of the one or more controlled devices comprise a recognition processing means that obtains information necessary for execution of the sub-task from the environmental information.

### Supplementary Note 15

The control system according to any one of Supplementary Notes 7 to 14, wherein both of the planning device and each of the one or more controlled devices comprise a control means that performs control so that the controlled device executes the sub-task based on the time series of the target values set by the second plan generation means.

### Supplementary Note 16

The control system according to any one of Supplementary Notes 13 to 15,
wherein the planning device and each of the controlled devices perform wireless communication with each other, and
wherein the planning device comprises an environmental evaluation means that outputs an evaluation value related to the wireless communication.

### Supplementary Note 17

The control system according to any one of Supplementary Notes 7 to 12, further comprising:
an environmental information input means that acquires environmental information that is information indicating a situation of a work space, the work space being a space in which the controlled devices perform the target task, and provides the environmental information to the planning device,
wherein one or more of the controlled devices comprise an observation means that acquires environmental information that is information indicating a situation of the work space, separately from the environmental information input means,
wherein both of the planning device and each of the one or more controlled devices comprise:
a recognition processing means that obtains information necessary for execution of the sub-task from the environmental information; and
a control means that performs control so that the controlled device executes the sub-task based on the time series of the target values set by the second plan generation means,
wherein the planning device and each of the controlled devices perform wireless communication with each other,
wherein the planning device comprises an environmental evaluation means that outputs an evaluation value related to the wireless communication, and
wherein the first plan generation means determines assignment of whether acquisition of the environmental information; acquisition of information necessary for the execution of the sub-task; and control of the controlled device to execute the sub-task are to be performed on the planning device side, the controlled device side, or both the planning device and the controlled device side.

### Supplementary Note 18

The control system according to any one of Supplementary Notes 7 to 17, comprising an input device that, for each type of object to be transported in the target task and for each destination, receives input of a number of objects on an input screen that receives the input of the number to be transported to the destination.

### Supplementary Note 19

The control system according to Supplementary Note 18, wherein the input device receives selection of any one of: a method of specifying a number of the controlled devices used for execution of the target task; a method of specifying the number as a fixed value; a method of specifying the number based on power consumption; or a method of specifying the number based on working hours.

### Supplementary Note 20

A control method executed by a computer that controls a plurality of controlled devices, comprising:
determining, in accordance with a target task that is a process to be executed by the controlled devices, an operation sequence for each of the controlled devices, the operation sequence being a time series of predetermined sub-tasks serving as operations capable of being executed by the controlled device or the computer itself;
setting, with regard to a sub-task that requires a setting of a time series of control target values with respect to the controlled device, among the sub-tasks included in the operation sequence, a time series of the target values for causing the controlled device to execute the sub-task; and
controlling the controlled devices based on the operation sequence and the target value time-series.

### Supplementary Note 21

A storage medium that records a program for causing a computer that controls a plurality of controlled devices to execute:
determining, in accordance with a target task that is a process to be executed by the controlled devices, an operation sequence for each of the controlled devices, the operation sequence being a time series of predetermined sub-tasks serving as operations capable of being executed by the controlled device or the computer itself;
setting, with regard to a sub-task that requires a setting of a time series of control target values with respect to the controlled device, among the sub-tasks included in the operation sequence, a time series of the target values for causing the controlled device to execute the sub-task; and
controlling the controlled devices based on the operation sequence and the target value time-series.

### INDUSTRIAL APPLICABILITY

The present invention may be applied to a control device, a control system, a control method, and a storage medium.

### DESCRIPTION OF REFERENCE SYMBOLS

100, 110, 120, 130, 140, 200, 610 Control system
1, 201, 612 Planning device
2 Input device
3 Storage device
4, 4a, 4b Mobile robot
5, 45a, 45b Observation device
11, 601, 613 First plan generation portion
12, 602, 614 Second plan generation portion
13, 43, 43a, 43b, 342, 243a, 243b Recognition processing portion
14, 44, 44a, 44b, 244, 244a, 244b, 603 Control portion
222 Environmental evaluation portion
25 Wireless communication
50 Abstract state setting space
60a, 60b Object
61, 62 Work table
600 Control device
611 Controlled device

What is claimed is:

1. A control device comprising:
a memory configured to store instructions; and
a processor configured to execute the instructions to:
determine, in accordance with a target task that is a process to be executed by a plurality of controlled devices, an operation sequence for each of the controlled devices, the operation sequence being a time series of predetermined sub-tasks serving as operations capable of being executed by the controlled device or the control device;
with regard to a sub-task that requires a setting of a time series of control target values with respect to the controlled device, among the sub-tasks included in the operation sequence, set a time series of the target values for causing the controlled device to execute the sub-task; and
control the controlled devices based on the operation sequence and the target value time-series.

2. The control device according to claim 1, wherein the processor is configured to execute the instructions to:
obtain a logical expression reflecting a target number of time steps for execution of the target task, the logical expression indicating a state in which the target task has been accomplished and a constraint condition in the execution of the target task; and
generate the operation sequence that satisfies the logical expression.

3. The control device according to claim 2, wherein the processor is configured to execute the instructions to generate the logical expression representing a state of each time step using a logical expression of temporal logic.

4. The control device according to claim 1, wherein the processor is configured to execute the instructions to, with regard to the sub-task that requires the setting of the time series of the control target values with respect to the respective controlled devices, among the sub-tasks included in the operation sequence, set the time series of the target values based on a constraint condition relating to the controlled device and discrete dynamics relating to a relationship between the controlled device and an object in the target task.

5. The control device according to claim 1,
wherein the controlled device is a mobile robot, and
wherein the processor is configured to execute the instructions to determine a plan that includes: moving the mobile robot to a set reference point; moving a robot arm of the mobile robot to a position for executing an operation related to the sub-task after the mobile robot has moved to the reference point; and causing the robot arm to execute an operation related to the sub-task after the robot arm has moved to the position for executing the operation related to the sub-task.

6. The control device according to claim 5, wherein the processor is configured to execute the instructions to set the reference point for each designated area.

7. A control system comprising:
a plurality of controlled devices; and
a planning device,
wherein the planning device comprises:
a memory configured to store instructions; and
a processor configured to execute the instructions to:
determine, in accordance with a target task that is a process to be executed by the controlled devices, an operation sequence for each of the controlled devices, the operation sequence being a time series of predetermined sub-tasks serving as operations capable of being executed by the controlled device or the planning device; and
with regard to a sub-task that requires a setting of a time series of control target values with respect to the controlled device, among the sub-tasks included in the operation sequence, set a time series of the target values for causing the controlled device to execute the sub-task.

8. The control system according to claim 7,
wherein the processor is configured to execute the instructions to:
obtain a logical expression reflecting a target number of time steps for execution of the target task, the logical expression indicating a state in which the target task has been accomplished and a constraint condition in the execution of the target task; and
generate the operation sequence that satisfies the logical expression.

9. The control system according to claim 8, wherein the processor is configured to execute the instructions to generate the logical expression representing a state of each time step using a logical expression of temporal logic.

10. The control system according to claim 7,
wherein the processor is configured to execute the instructions to, with regard to the sub-task that requires the setting of the time series of the control target values with respect to the respective controlled devices, among the sub-tasks included in the operation sequence, set the time series of the target values based on a constraint condition relating to the controlled device and discrete dynamics relating to a relationship between the controlled device and an object in the target task.

11. The control system according to claim 7,
wherein the controlled device is a mobile robot, and
wherein the processor is configured to execute the instructions to determine a plan that includes: moving the mobile robot to a set reference point; moving a robot arm of the mobile robot to a position for executing an operation related to the sub-task after the mobile robot has moved to the reference point; and causing the robot arm to execute an operation related to the sub-task after the robot arm has moved to the position for executing the operation related to the sub-task.

12. The control system according to claim 11, wherein the processor is configured to execute the instructions to set the reference point for each designated area.

13. The control system according to claim 7,
wherein the processor is configured to execute the instructions to:
acquire environmental information that is information indicating a situation of a work space, the work space being a space in which the controlled devices perform the target task; and
provide the environmental information to the planning device,
wherein one or more of the controlled devices comprise a processor configured to acquire environmental information that is information indicating a situation of the work space, separately from the environmental information acquired by the processor of the control system.

14. The control system according to claim 13, wherein both of the planning device and each of the one or more controlled devices comprise a processor configured to obtain information necessary for execution of the sub-task from the environmental information.

15. The control system according to claim 7, wherein both of the planning device and each of the one or more controlled devices comprise a processor configured to perform control so that the controlled device executes the sub-task based on the time series of the target values.

16. The control system according to claim 13,
wherein the planning device and each of the controlled devices perform wireless communication with each other, and
wherein the planning device comprises a processor configured to output an evaluation value related to the wireless communication.

17. The control system according to claim 7,
wherein the processor is configured to execute the instructions to acquire environmental information that is information indicating a situation of a work space, the work space being a space in which the controlled devices perform the target task, and provides the environmental information to the planning device,
wherein one or more of the controlled devices comprise a processor configured to acquire environmental information that is information indicating a situation of the work space, separately from the environmental information acquired by the processor of the control system,
wherein both of a processor of the planning device and the processor of each of the one or more controlled devices are configured to:
obtain information necessary for execution of the sub-task from the environmental information; and
perform control so that the controlled device executes the sub-task based on the time series of the target values,
wherein the planning device and each of the controlled devices perform wireless communication with each other,
wherein the processor of the planning device is configured to output an evaluation value related to the wireless communication, and
wherein the processor of the control system is configured to execute the instructions to determine assignment of whether acquisition of the environmental information; acquisition of information necessary for the execution of the sub-task; and control of the controlled device to execute the sub-task are to be performed by the planning device, the controlled device, or both the planning device and the controlled device.

18. The control system according to claim 7, wherein the processor is configured to execute the instructions to, for each type of object to be transported in the target task and for each destination, receive input of a number of objects on an input screen that receives the input of the number to be transported to the destination.

19. The control system according to claim 18, wherein the processor is configured to execute the instructions to receive selection of any one of: a method of specifying a number of the controlled devices used for execution of the target task; a method of specifying the number as a fixed value; a method of specifying the number based on power consumption; or a method of specifying the number based on working hours.

20. A control method executed by a computer that controls a plurality of controlled devices, comprising:
determining, in accordance with a target task that is a process to be executed by the controlled devices, an operation sequence for each of the controlled devices, the operation sequence being a time series of predetermined sub-tasks serving as operations capable of being executed by the controlled device or the computer;
setting, with regard to a sub-task that requires a setting of a time series of control target values with respect to the controlled device, among the sub-tasks included in the operation sequence, a time series of the target values for causing the controlled device to execute the sub-task; and
controlling the controlled devices based on the operation sequence and the target value time-series.

21. (canceled)
